(19) United States
(12) Patent Application Publication
(10) Pub. No.: US 2016/0328453 A1
(43) Pub. Date: Nov. 10, 2016

(54) VERACITY SCALE FOR JOURNALISTS

(71) Applicants: SONY CORPORATION, Tokyo (JP); Sony Network Entertainment International, Inc., Los Angeles, CA (US)

(72) Inventor: Albhy Galuten, Santa Monica, CA (US)

(21) Appl. No.: 15/213,012

(22) Filed: Jul. 18, 2016

Related U.S. Application Data
(63) Continuation-in-part of application No. 14/981,753, filed on Dec. 28, 2015.
Application No. 14/981,753 is a continuation-in-part of application No. 14/846,624, filed on Sep. 4, 2015.
(60) Provisional application No. 62/106,605, filed on Jan. 22, 2015.
(60) Provisional application No. 62/046,501, filed on Sep. 5, 2014.
(60) Provisional application No. 62/207,781, filed on Aug. 20, 2015.

(51) Int. Cl. G06F 17/30

(52) U.S. Cl. CPC G06F 17/30528; G06F 17/30312; G06F 17/30554; G06F 17/30864

(57) ABSTRACT

The methods and systems take into account a multiplicity of approaches to reputation determination and integrates them together in a way that determines not only a reputation index but a veracity scale on which to gauge that reputation. The system proposed herein will create reputation indices based on input from other participants in the ecosystem taking into account the weighting of the value of the input of the various participants based on their credibility as applied to the judgment at hand. The system will also take into account temporal components, the historical value of the work, passive input based on usage behavior, comments by casual observers as well as independent assessment in public fora. The system is able to be applied to journalists and their work to generate a veracity scale for articles.

### CROSS-REFERENCE TO RELATED APPLICATION(S)

This application is a continuation-in-part application of co-pending U.S. patent application Ser. No. 14/981,753, filed Dec. 28, 2015, and titled “SYSTEM AND METHODS FOR DETERMINING THE VALUE OF PARTICIPANTS IN AN ECOSYSTEM TO ONE ANOTHER AND TO OTHERS BASED ON THEIR REPUTATION AND PERFORMANCE,” which claims priority under 35 U.S.C. §119(e) of the U.S. Provisional Patent Application Ser. No. 62/106,605, filed Jan. 22, 2015 and titled, “HYBRID REPUTATION ENGINE” and which is a continuation-in-part application of co-pending U.S. patent application Ser. No. 14/846,624, filed Sep. 4, 2015, and titled “SYSTEM AND METHODS FOR CREATING, MODIFYING AND DISTRIBUTING VIDEO CONTENT USING CROWD SOURCING AND CROWD CURATION,” which claims priority under 35 U.S.C. §119(e) of the U.S. Provisional Patent Application Ser. No. 62/046,501, filed Sep. 5, 2014 and titled, “SYSTEM AND METHODS FOR CREATING, MODIFYING AND DISTRIBUTING VIDEO CONTENT USING CROWD SOURCING AND CROWD CURATION,” which are all hereby incorporated by reference in their entireties for all purposes. This application also claims priority under 35 U.S.C. §119(e) of the U.S. Provisional Patent Application Ser. No. 62/207,781, filed Aug. 20, 2015 and titled, “VERACITY SCALE FOR JOURNALISTS,” which is hereby incorporated by reference in its entirety for all purposes.

### FIELD OF THE INVENTION

The system and methods pertain generally to the reputations of entities or individuals. People perform many tasks and others have opinions about how well they perform those tasks. For some tasks, the success of the person performing that task can be measured by success in the marketplace. This system and methods pertain to the field of establishing reputation based on a number of these features.

### BACKGROUND OF THE INVENTION

Today, people review the work of others in a few areas. Angie's list applies to workers in the home improvement trade. Trip Advisor applies to the quality of lodging and other locations and services tourists typically use. Facebook uses a “thumbs-up” and “thumbs-down” approach to liking things or not. None of these systems integrate a holistic approach to the multiple axes that can combine to create a more robust form of reputation grading.

### BRIEF SUMMARY OF THE INVENTION

The summary herein includes exemplary embodiments and is not meant to be limiting in any way.

In one aspect, a method programmed in a non-transitory memory of a device comprises acquiring input from a user regarding an article or a journalist, collating and storing the input in a database, filtering the input to generate filtered data, applying a user-specific filter to the filtered data to generate veracity information related to the article or the journalist and displaying the veracity information. The user is one of a registered user or a non-registered user, wherein the input from the registered user is valued more than the input from the non-registered user. The input from the user is classified based on breadth of the input, such that the input with more breadth is more valuable than input with less breadth. The input from the user is a rating of the article based on one or more parameters. The one or more parameters include at least one of: current accuracy, historical accuracy, writing style, understandability, bias and relevance to a topic. The one or more parameters are dynamic such that the one or more parameters evolve over time based on feedback, amount of use, or value in determining outcomes. The input from the user includes information to generate an additional parameter. The additional parameter is added to a parameter list upon being approved by a specified number of users. When a parameter of the one or more parameters is rarely used, the parameter is removed from the parameter list. The one or more parameters are displayed in a grid with a scale rating in a web browser. The user has a veracity index based on an expertise of the user and historical accuracy of the user.

In another aspect, an apparatus comprises a non-transitory memory for storing an application, the application for: acquiring input from a user regarding an article or a journalist, collating and storing the input in a database, filtering the input to generate filtered data, applying a user-specific filter to the filtered data to generate veracity information related to the article or the journalist and displaying the veracity information and a processing component coupled to the memory, the processing component configured for processing the application. The user is one of a registered user or a non-registered user, wherein the input from the registered user is valued more than the input from the non-registered user. The input from the user is classified based on breadth of the input, such that the input with more breadth is more valuable than input with less breadth. The input from the user is a rating of the article based on one or more parameters. The one or more parameters include at least one of: current accuracy, historical accuracy, writing style, understandability, bias and relevance to a topic. The one or more parameters are dynamic such that the one or more parameters evolve over time based on feedback, amount of use, or value in determining outcomes. The input from the user includes information to generate an additional parameter. The additional parameter is added to a parameter list upon being approved by a specified number of users. When a parameter of the one or more parameters is rarely used, the parameter is removed from the parameter list. The one or more parameters are displayed in a grid with a scale rating in a web browser. The user has a veracity index based on an expertise of the user and historical accuracy of the user.

In another aspect, a system comprises an acquisition module for acquiring input from a user regarding an article or a journalist, a collating module for collating and storing the input in a database, a filtering module for filtering the input to generate filtered data, a user-specific filtering module for applying a user-specific filter to the filtered data to generate veracity information related to the article or the journalist and a display module for displaying the veracity information. The user is one of a registered user or a non-registered user, wherein the input from the registered user is valued more than the input from the non-registered user. The input from the user is classified based on breadth of the input, such that the input with more breadth is more valuable than input with less breadth. The input from the user is a rating of the article based on one or more parameters. The one or more parameters include at least one of: current accuracy, historical accuracy, writing style, understandability, bias and relevance to a topic. The one or more parameters are dynamic such that the one or more parameters evolve over time based on feedback, amount of use, or value in determining outcomes. The input from the user includes information to generate an additional parameter. The additional parameter is added to a parameter list upon being approved by a specified number of users. When a parameter of the one or more parameters is rarely used, the parameter is removed from the parameter list. The one or more parameters are displayed in a grid with a scale rating in a web browser. The user has a veracity index based on an expertise of the user and historical accuracy of the user.

### BRIEF DESCRIPTION OF THE DRAWINGS

The invention will be more fully understood by reference to the following drawings which are for illustrative purposes only:

FIG. 1 is a high level overview of the steps in the creative process up to the distribution of the filmed/video asset.

FIG. 2 is a view of the script registration flow.

FIG. 3 is a view of the contractual parameters of script ownership and control.

FIG. 4 is a view of the parsing flows for e-contracts.

FIG. 5 is a view of the process for registering ideas and scripts.

FIG. 6 is a view that shows the linking of the content registry and the e-contracts.

FIG. 7 is a view that shows the participant selection flow.

FIG. 8 is a view that shows the functioning of granular reputation engine.

FIG. 9 is a view of the Scripted Agora.

FIG. 10 is a view of the Documentary Agora.

FIG. 11 is a view of the Footage Repository.

FIG. 12 is a view of the Reality Agora.

FIG. 13 is a view of the Agency Agora.

FIG. 14 is a view of the Legal Agora.

FIG. 15 is a view of the Filming Agora.

FIG. 16 is a view of the Special Effects process.

FIG. 17 is a view of the Amateur Agora, Collecting Data.

FIG. 18 is a view of the Amateur Agora, Finding Talent.

FIG. 19 is a view of the Distributed Video Agora, Finding Commercial Videos.

FIG. 20 illustrates a block diagram of an exemplary computing device configured to implement the video development method according to some embodiments.

FIG. 21 is a diagram of the architecture for Reputation and Recommendation.

FIG. 22 is a diagram of a detailed view of the gathering of Reputation Data.

FIG. 23 is a diagram of a detailed view of the Reputation Data analysis.

FIG. 24 is a diagram of a view of Reputation Collation Engine analysis with metadata.

FIG. 25 is a diagram which addresses capturing recommendations from across this diverse space.

FIG. 26 is a diagram of using the Reputation Data analysis with a query.

FIG. 27 illustrates a flowchart of a process of assessing veracity according to some embodiments.

FIG. 28 illustrates a chart of the value of sources according to some embodiments.

FIG. 29 illustrates a diagram of analyzing user input to generate veracity information according to some embodiments.

### DETAILED DESCRIPTION OF THE PREFERRED EMBODIMENT

The video development method is broken into a number of serial and parallel processes. The Idea:

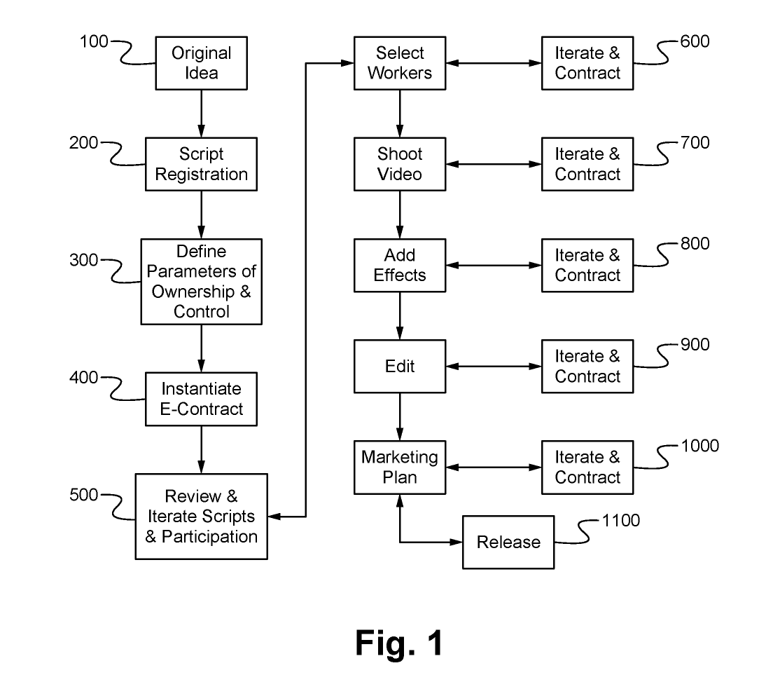

Video content begins with an idea. This could be an idea for a scripted TV show or series or a theatrical movie. It could also be an idea for a framework for a reality TV show or a documentary. The idea needs to be instantiated and protected and the legal arrangement among the creators needs to be codified and registered. Current copyright registration is not granular enough to sufficiently protect the contributions of multiple parties who do not have a pre-defined working relationship. The video development method defines a chain of participation that is both granular and accountable. An overview of the complete process is able to be seen in FIG. 1

### (Lifecycle Overview).

A Project or Original Idea (100) is started by one or more “originators.” These originators register their first script or their outline for a reality show or a documentary (200). All participants registering their participation (either initially or later) must have credentials that are able to be associated with their real person or entity. Each entity (a corporation or partnership could be a participant) must have a digital signature which is binding in a court of law and a mechanism for assuring the robustness of that signature as outlined in, for example the United Nations Convention on the Use of Electronic Communications in International Contracts or as provided by mechanisms like DocuSign or EchoSign.

The registration defines both the percentage of ownership and the percentage of control (300) and is stored in detail in an Electronic or E-Contract. All decisions made after this are subject to a secure vote of the participants based on their percentage of control. Revenues that accrue are based on the percentage of ownership. Some decisions may be designated as “super-majority” decisions. Super majority decisions are able to be defined as a percentage of participants from anywhere greater than 50% to 100%. So, for example, if there are 5 people who equally share control (20% each), and they select a super-majority of 80%, and they determine, for example, that in order to sell all of the rights, there must be a super-majority, then four people would need to agree in order to sell the property. There are able to be multiple levels of super-majority, (e.g. super-majority1, super-majority2, super-majority3, and so on), and these are able to be associated with percentages. Typically, one level might be set at 100% (unanimity) for the most important decisions. Having multiple levels of super-majority might be most relevant when there are a large number of participants (there could be hundreds).

As is described herein, people other than creators are able to be involved in either the ownership or the control. For example an actor or a director might have a percentage of either or both. Again, by way of example, suppose a writer has created a script and wants to bring on a Producer and a Director. That writer might give the Director and Producer certain levels of control based on their bi-lateral negotiation—e.g., 25% for the Producer and 35% for the Director, leaving 40% for the original creator. The three parties might then agree to be bound by three different super-majorities: 60% (or super-majority1) for decisions that are able to be made by any two of the three participants, 65% (or super-majority2) for decisions that are able to be made by the Creator in agreement with either the Producer or the Director and 100% (or supermajority 3) for those decision that require unanimous agreement. At some point, they convince a distributor to get involved. They might agree to give that distributor 75% ownership until costs are recouped and 50% ownership after that in exchange for an agreed amount of money they will commit to fund and market the production and distribute the title. However, they might cede only 49% of the control so that if the three original principles make a decision, the distributor cannot unilaterally veto it. Also, non-votes or abstentions are able to be counted as either no votes or as not part of the percentage (as is common in different kinds of governing structures).

Continuing with FIG. 1 (Lifecycle Overview), next the content is iterated and reviewed (500). During this process other workers are found and their degree of control or participation or other form of remuneration is negotiated and securely and robustly codified in continuing E-Contracts or extensions of existing E-Contracts. As various workers are found (writers, actors, others), they are reviewed and contracts are negotiated and signed (600). This process is repeated for Camera Operators (700), Special Effects Workers (800), Editors (900), Marketers (1000) and Distribution Channels (1100).

### Initial Script Registration:

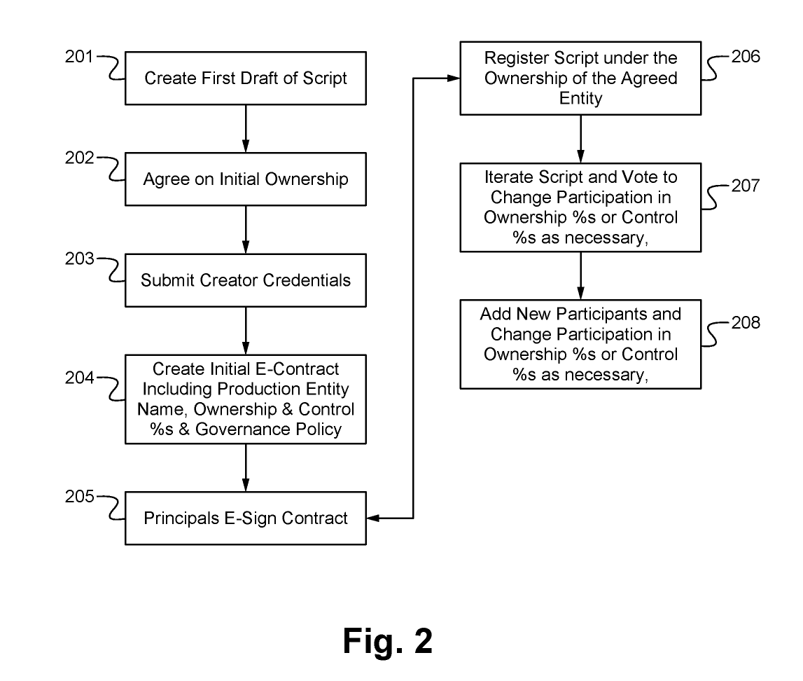

The flows for an Initial Script Registration are able to be seen if FIG. 2 as follows.

First, one or more Creators create the initial instantiation of the script or idea (201). Next they agree on their initial ownership and control percentages (202) and generate their Creator Credentials (203) using accountable robust E-Identities and create an E-Contract that accurately describes the desired contractual relationship. The parties then sign the E-Contract (205) with their Digital Credentials. After the contractual relationship is established and certified, the Script or Idea is Registered under the name of the Agreed Entity (206). The Script or Idea is able to be iterated and degrees of participation and/or control is able to be changed as necessary (207). New participants in the participation or control are able to be added as necessary (208) using the same mechanisms.

### Entity Structure:

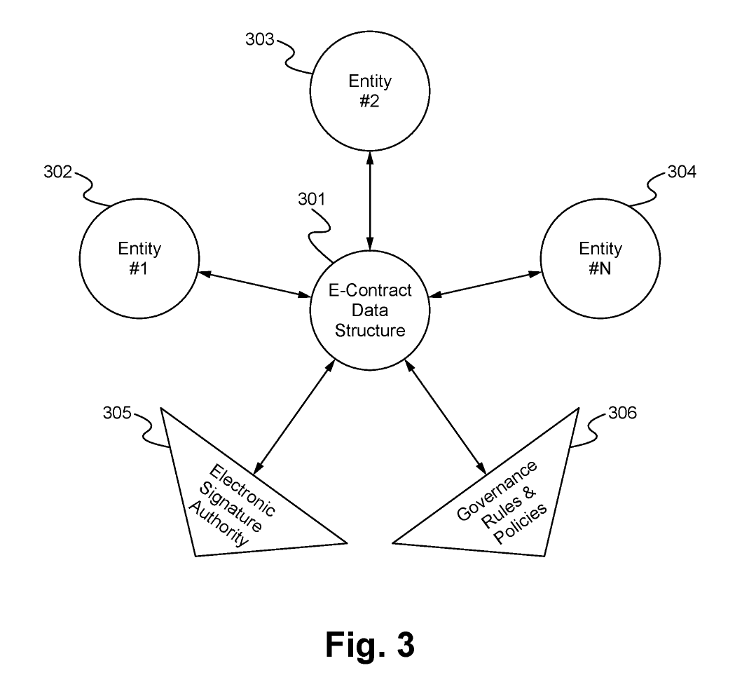

A view of the contractual relationships is able to be seen in FIG. 3. At the center of the process is a data structure known as an E-Contract. This E-Contract (310) codifies, in a binding fashion the relationship among the signing parties (302, 303 and 304). The signatures are guaranteed by and Electronic Signature Authority (301). The E-Contract also codifies and ensures the robustness of the Policies and Rules of Governance (306).

### Electronic Contracts:

The whole preceding section speaks to an electronic representation of the contractual relationships among the parties. The contracts are represented as data structures with fields representing parameters and variables in those fields representing the number associated with the variable. To use as an example the super-majorities as described above, there would be three super-majority fields. Super-majority field one would have a value of 60%, super-majority field two would have a value of 65% and super-majority field three would have a value of 100%. There would also be a default field for simple majority of 50%. Various parameters would be associated with different voting majority variables. Suppose that the decision of Lead Actor is governed by super-majority 2; that would be a parameter of the lead actor selection portion of the data structure that expresses the contractual agreement. When a lead actor is voted upon, the success or failure of a person for that position is subject to the result of the vote. The result of the vote might next trigger an offer price being agreed upon. The offer price up to a certain cap might be subject to only a simple majority vote. Once an offer amount is proposed and agreed by vote, an offer is able to be made to the actor.

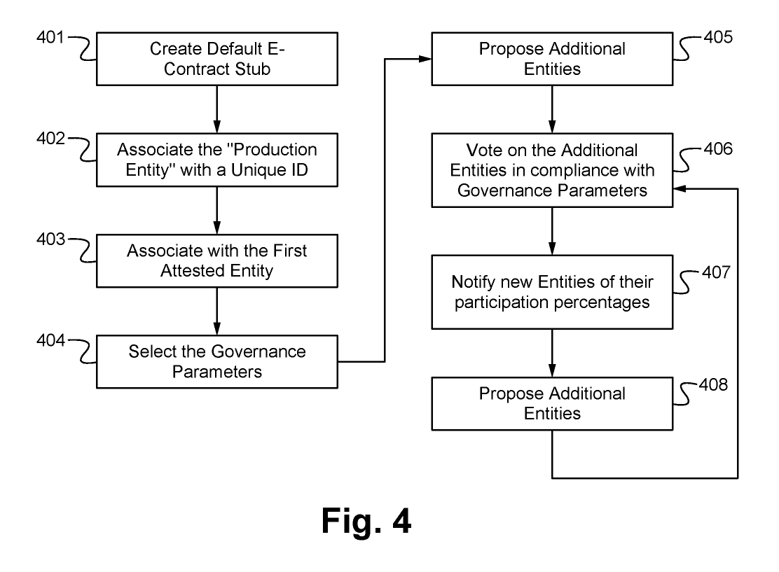

FIG. 4 shows another view of the E-Contract generation and use process. First, an E-Contract Stub (401) is created. This is a data structure into which the rules and parameters and credentials will be placed. Next, a Registered and Unique Production ID is associated with the E-Contract (402). Next, one or more Entities (e.g. persons, partnerships, corporations, others) are associated with the initial Entity (403). Next, Governance Parameters are selected (initial default parameters could be accepted) and are voted upon (404). Other Entities are able to be added to the legal structure (405) and voted upon (406). The entities are then officially notified of the new contractual relationship. New entities (407) are able to be added at any time repeating the loop of proposal (408), Voting and Approval (406) and Notification (407).

The same general processes are able to be used to generate offers to all types of Talent, including the offering of percentages of revenue or control.

Once an entity has been voted the right to participate in control, they will become part of the voting process unless and until there is a new binding vote successfully reverses that right.

### Protecting the Idea:

The creative contributors must have protection of their ideas so that they are able to appropriately participate in the revenue streams that are generated from those ideas. In order to ensure the flexibility of both the creative and development process, when an idea is first generated, the idea will be registered in a robust and secure fashion so that it cannot be tampered with. This is similar to how ideas are today registered with the Writer's Guild (https://www.wgawregistry.org) but more granular and detailed in their electronic representation. Registered material should be in digital form so that it is searchable by machines. Registered material should contain detailed meta-data including: genre (scripted, documentary, reality) and sub-genre (mystery, romantic comedy); owners and controllers and the locations of their agreements and digital signatures, locations and version numbers of all historical versions. Registered ideas will be escrowed for the purpose of forensic investigation. They need not be reviewed by people or parsing algorithms for originality however the provenance of the registration must be uncontestable.

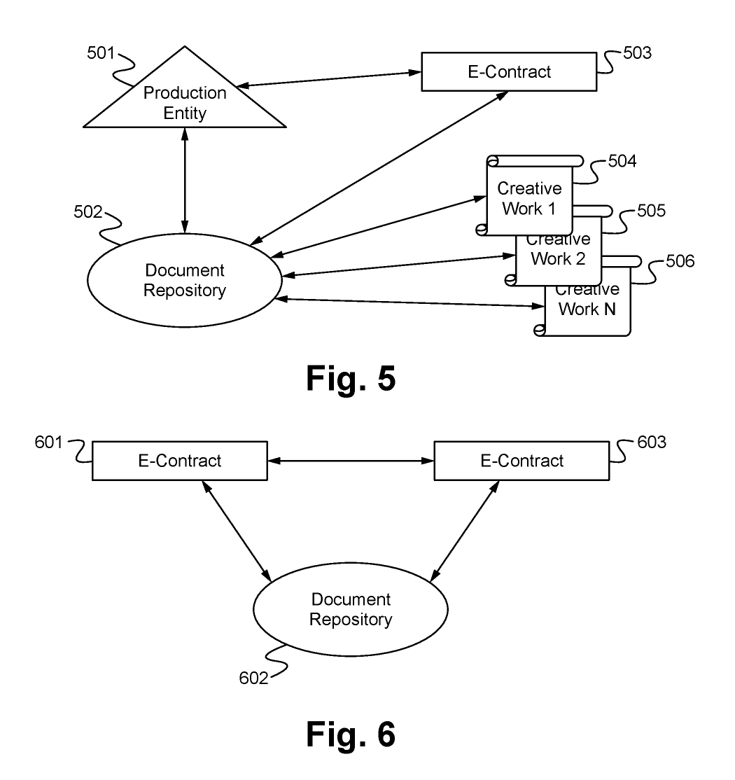

The Idea Registration Flow is able to be seen in FIG. 5 and is as follows.

1) There is a Certified Document Repository (502). This repository is secure and robust and documents or files have clear provenance as attested to by certificates in order to be stored.

2) Associate the Production Entity (501) with the Document Repository (502). When a creative work is deposited in the Repository Associated with the Production Entity, control and ownership parameters are associated with the creative work and codified in the E-Contract (503) of the Production Entity. Each modification of the Creative Work is subject to the Ownership and Control Parameters of the Production Entity as expressed in its E-Contract(s). Ownership and Control Parameters may be changed as per the E-Contract of the Production Entity.

3) Place Creative Works (504, 505, 506) in the Document Repository.

As is able to be seen in FIG. 6, there is an electronic linking between the Document Registry (501) and the Document Repository (502) which is defined and certified by the E-Contract (503).

### The Virtual Agora

The original Agora in ancient Greece was the chief marketplace and the center of civic life. This Virtual Agora is able to be the center of a creative marketplace where ideas are able to flourish as they did between Socrates and Plato in the original Agora.

### Selecting Participants:

The power of crowd creation is that the potential number of collaborators is vast. Because of the requirement of accountability, every registered participant must be associated with a real person or entity.

### Participant Registration:

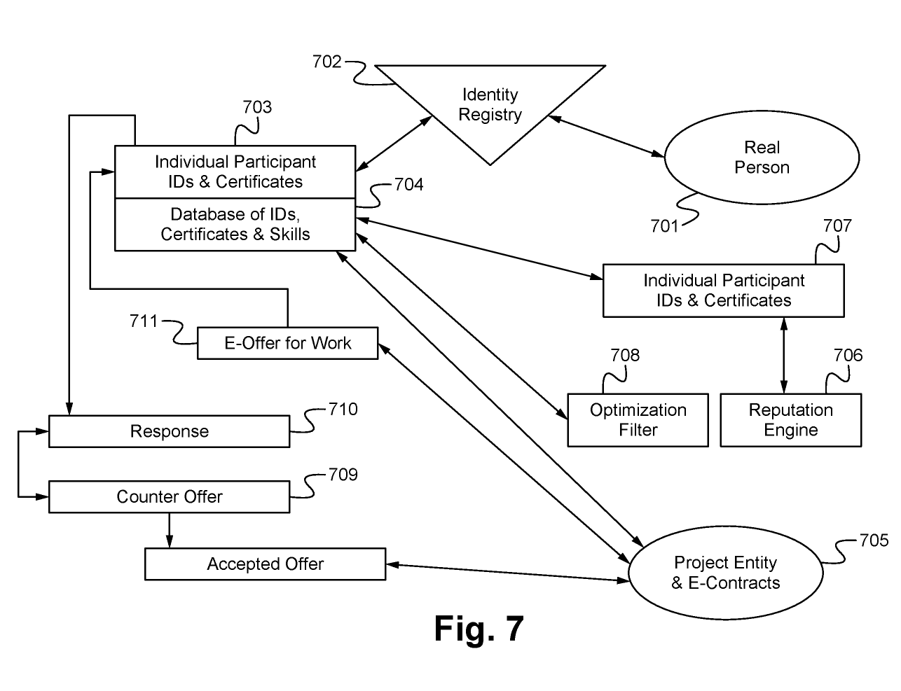

As shown in FIG. 7, each Participant (701) begins by registering to a secure Identity Registry Database (702) with their real identity. Then each participant is given an Identity Certificate (essentially a small E-Contract) that lives in a database (703) along with their Aliases and list of skills (704). The Identity Certificate is able to negotiate on their behalf when negotiating with the Certificates or E-Contracts of other entities. The Participant then populates their Identity Certificate with their list of skills and any aliases they may want to use, and these are able to be updated at any time. Aliases are able to be used to protect famous people and allow them to participate among the masses. These aliases, while opaque to the other registrees, are transparent with respect to legal accountability. The system must keep track of the various aliases so that, for example, a famous writer is able to throw ideas into this Virtual Agora without having them prejudicially judged.

When a Project Entity (e.g. a movie or a TV show) (705) wants to negotiate with an Individual Participant for the use of their skills, they take the following steps:

1) They look up the individual in the database of skills and IDs (704).

2) They may check their reputation using the Reputation Engine (706) which gets its information from the Reputation Information Database (707).

3) They may use an Optimization Filter (708) to limit their choices.

4) They make an offer for work (711). This could include dates and pay rates. It could include percentages of net or gross.

5) The Individual Participant (through the E-Contract mechanism) responds.

6) There may be an unlimited number of counter offers and responses (709, 710).

7) Ultimately, the offer is either accepted or rejected.

### Granular Reputation Engines:

Having allowed for anonymity, many or most creators will be trying to build their reputation. If others think their writing or editing or directing is good, they should be able to develop a reputation index that is trusted.

There are many axes around which reputation is able to revolve. Participants in the Virtual Agora will receive reputation scores on different axes from different people that they have worked with. Some areas to be indexed might be: promptness, reliability, honesty, ability to solve problems, respect from others and respect for others. There will also be granular details for each discipline. For example, writers might be indexed on: commercial viability, comic dialog, dramatic dialog, scene description, plot development, character development for leading men, character development for leading women, character development for support men. These indices should be seeded initially as an expert system where experts in the field have determined the initial fields of reputation for each discipline. Once the field choices have been seeded, they should be dynamically updated (like a neural network) based on popularity. New fields will be added dynamically and are able to be based on suggestions from the Agora; rarely used characterizations are able to be pruned electronically, and new characterizations are able to have a trial period.

When reviewers rate others, there is no need to select all indices (many surveys require all questions to be answered but that is not the case here). As little as one comment on a participant's capabilities along one axis is still of value.

In addition to reputation based on Individual Participants, there is also reputation based on Awards, Reviews and Anonymous posts, blogs and web sites.

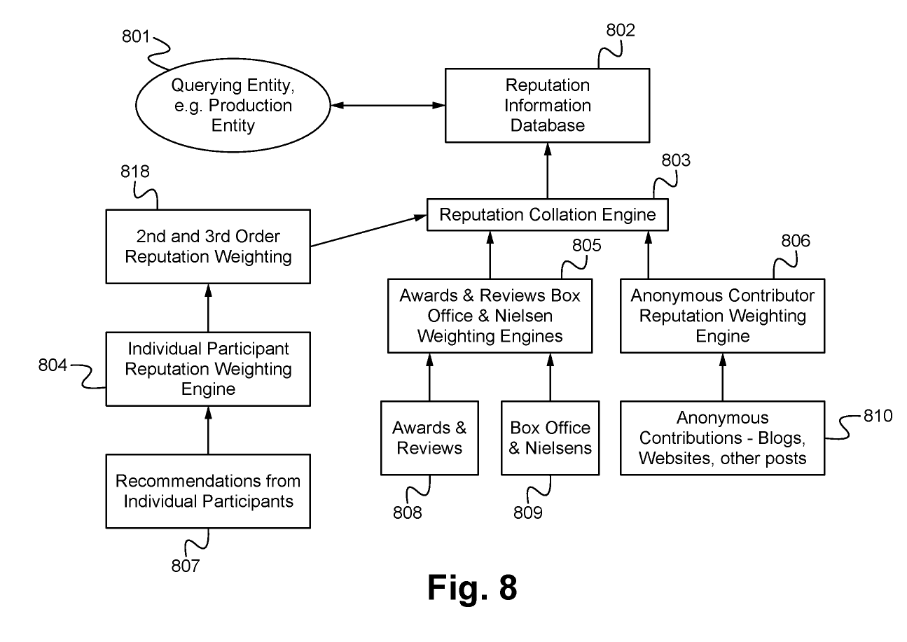

As is able to be seen in FIG. 8, the Querying Entity (typically the Production Entity) (801) queries the Reputation Information Database (802) for reputations of individuals it is interested in. It may ask for the recommendations from a broad set of possible contributors based on parameters such as class, location reputation and/or historical price. Reputations are collected from multiple sources. There are the explicit recommendations from the Individual Participants in the ecosystem (807) (e.g., people who have worked with the individual in question or have opinions about their work). There is the collation of Awards, Reviews (808) and Box Office success or Nielsen Ratings (809), and there are Anonymous Contributions (810) from blogs, websites and other posts.

One additional factor to be included in the creation of the reputation indices is the weighting of the value of each recommendation (804, 805, 806). For example, if a reviewer, such as, a director, has a historical box office of multiple successful movies, their recommendation on the commercial viability of a writer would be weighted more heavily than an unknown director. The reviewers are able to not only be rated on publicly available data like box office success but also on historical accuracy. For example, if a person who has reviewed hundreds of actors gives 10 new actors a high rating, and those actors go on to be successful, that person's reviewer rating, with regard to selection of actors, will be high.

Individual reviews are able to be read. Individual reviewers may be anonymous to the searcher but not anonymous to the system so that the reader is able to value the reviewer based on their Reputation. Because of the de-referencing of the Reputations (818) and weighting based on degrees of separation, a reviewer's veracity is also generated. For example, if the user is looking for a Camera Operator who is particularly good at long shots, the user will start with those Camera Operators, among all the camera operators in the system (not just those who are available or local) who have been noted as good at long shots (the pool of Camera Operators will be smaller because many recommendations may be silent on that particular aspect) and see which of those have recommended Camera Operators in the pool of possible Camera Operators. This is able to be done expanding by a couple of degrees—that is not just those who have been recommended by people known to be good at long shots but also people who have been recommended by people who were recommended by people who are known to be good at long shots (2nd degree of separation). This would be weighted slightly lower than those who have recommended directly. Reviewers who are a 3rd degree of separation away are able to also be factored into the ratings of the Camera Operators but would be weighted less than those reviewers who are separated by one degree or two degrees.

Veracity, as well as other aspects of the methods described herein, is able to be used with respect to other entities such as journalists. For example, the rate of accuracy of journalists in publications or other media including analyzing the historical accuracy of their predictions is able to be utilized.

Different kinds of content use different creative environments and are broken down, below. Sub-genres are also possible.

### The Scripted Agora:

The history of multiple writers working on a script is long and storied. Often, one writer begins a project and others finish it. Using the control mechanisms above, this is able to still happen. If, for example, the studio has control, they are able to act unilaterally. If they have 40% control and the director has 15% control, they could only do this if the Studio and Director were in agreement. This is similar to how things have been done (though this is more formally defined). However, there are new mechanisms that are able to be used based on the scale of the Virtual Agora. For example, a user has a movie written, but the user does not think the opening is dynamic enough. The user could send out a bid for writing the opening 5 minutes and offer 5% of the writing ownership and a credit that read, “Opening sequence written by . . . ” The user could then ask the community to read the new openings and score them. The user could factor the value of the rating based, partly, on if the reviewer says they have read the whole script or only the new opening. The user could then read the most highly reviewed and choose one or not. All the openings would be kept in the network so that if the user tried to steal someone else's idea, they would have the forensic evidence to support a claim.

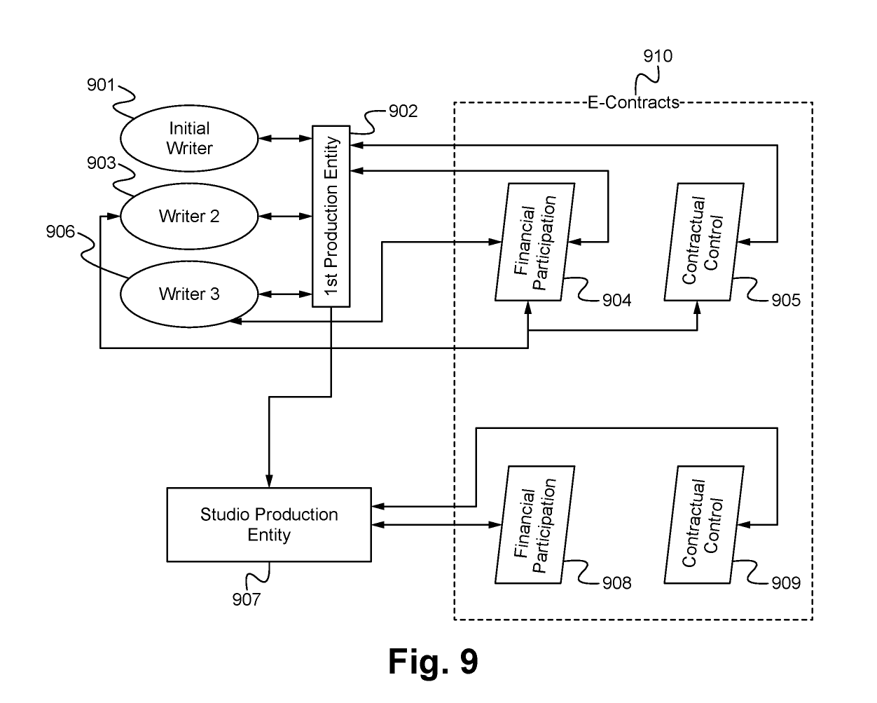

To help clarify the mechanism, a walk through is described herein of one specific scenario as outlined in FIG. 9. Mary is a writer (901) and begins working on a script. Mary creates or already has a Production Entity (902) governed by an E-Contract (910). Mary's initial rights are 100% Ownership (904) and 100% Control (905). Mary likes the general direction but as she has never written an action script before, so she asks John (903) to work on it with her. Because she trusts John and knows he has a lot of experience selling scripts, she agrees to give him an equal share of both ownership and control. Because the bylaws of Mary's Production Entity (902) as expressed in her E-Contract (910) require a super majority of 60% in order to change ownership or control, she knows that they will both have to agree in order to change ownership or control. Mary forms an E-Offer and sends it to John who accepts and signs the acceptance with his digital signature. After working on it for a while, they realize they would like a bit more polish so they bring in a third writer, Bernie (903). They agree to give Bernie a 10% Revenue Share of the Writer's portion of the revenue from the final movie including advances, subject to further dilution if other writers are brought in. Mary and John put together an E-Offer reflecting that participation, vote on it electronically, and the offer is sent to Bernie who accepts it by signing with his Digital Signature. It is stored in the E-Contract (910) as a change to the Financial Participation (904).

Mary and John then go to Amy, a studio executive they know and show her the script. Amy likes the script and instructs her lawyers to make an offer. The Studio (907) makes an E-Offer to Mary's Production Entity. Mary and John want the right to approve the Director and make a counter offer. The Studio wants the right to terminate if they cannot agree on the initial choice of Director with Mary and send their own Counter E-Offer. Mary and John want to accept. The vote electronically to accept the offer meeting the 60% supermajority required for such decisions and Mary's Production Entity send the signed response to the Studio. Note that though the votes were signed by Mary and John, the acceptance was signed by the First Production Entity. The First Production Entity is now a sub-contractor to the Studio Production Entity and the rights of the First Production Entity are now codified in the Studio Production Entities E-Contract with the First Production Entity (908 & 909).

### The Documentary Agora:

In the first phase, the Documentary Agora is not very different from other Agoras—people write bits of an outline or proposal instead of a script, and they share in the ownership. This is analogous to the way FIG. 9 works and is able to be applied in a similar fashion. The Documentary Agora, however, creates some new and interesting possibilities. Camera operators have their own Agora as people hired to film events, people or others. However, in the Documentary Agora, you may have lots of disparate bits of film created independently by separate people using their own equipment to capture some event. For example, suppose a user wanted to document Times Square on New Year's Eve? The user could put a call out to the Agora for people to film using whatever device they have (perhaps including many mobile phones) and to submit it to be curated by the crowds. People could rate the various clips. Using audio fingerprinting, all the videos could be synchronized. Then the video could be assembled using algorithms or by an editor who's decisions were informed by the ratings of the different clips. This could be done for any event from a rock concert to a demonstration in Kiev's central square. These documentaries might be made of clips from people who agreed to allow their videos to be used for free (phone videos from participants or audience members) mixed with videos from professional cameramen who submitted their videos subject to compensation. All the compensation could be pre-arranged based on click licenses that were digitally signed.

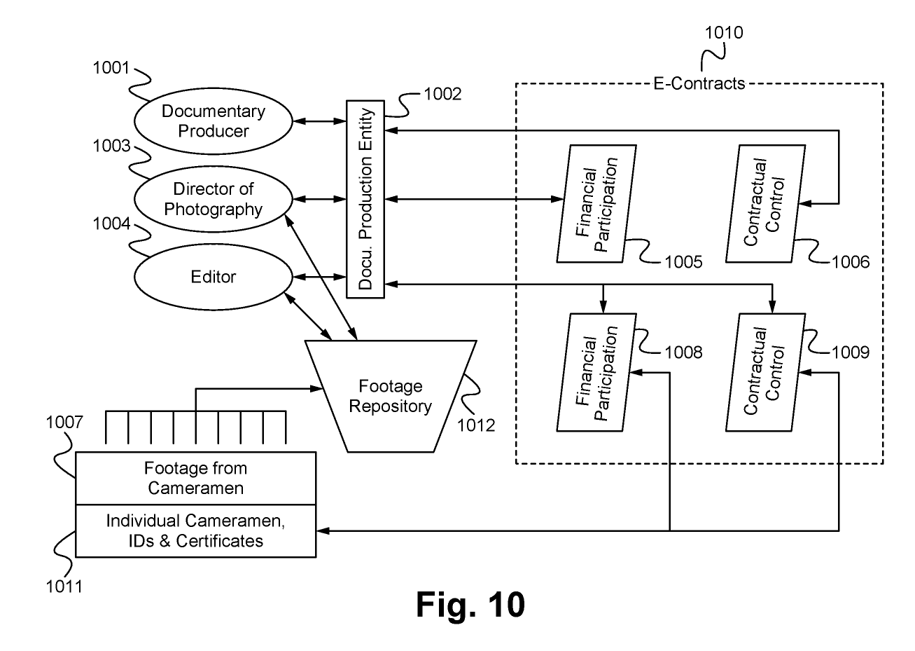

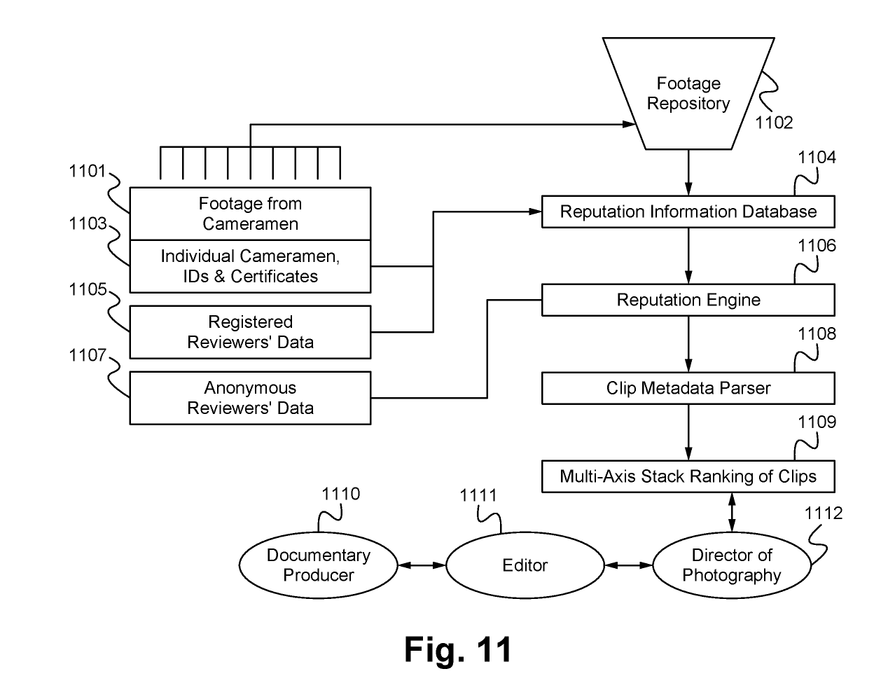

To help clarify the mechanism, one specific scenario is outlined in FIG. 10. For example, Christos and Marios have been to many Greek Festivals in the United States and want to document the food and dancing across the country. They go to a Production Entity creation web site and fill out the forms to create the “Greek Festivals Production Company” (Docu. Production Entity, 1002). They select the bylaws from a set of preconfigured possibilities; they pay the partnership fees and use their digital credentials to sign the documents. They do not know exactly what the form the documentary will take and are open to any possibilities, so they find an experienced Director of Photographer (1003) and an experienced Editor (1004) and sign E-Contracts with both of them for some Financial Participation (1005). For Control (1006) over the process, they agree that the DP (Director of Photography) gets 33% control over the selection of the footage, and the Editor gets 33% control over the way it is edited.

In order to find the best footage, the DP puts out a request to the Cameraman's Agora (1011) for cameramen who have high-quality footage (1007) of Greek festivals across the United States. Cameramen, who are interested, sign an E-Contract stipulating their payment participation (1008)—a small % based on the amount of footage used; their credit (1009)—e.g., as a cameraman if, for example, more than 1 minute of footage is used; and giving the production entity the rights to use the footage. There are a few cameramen who have a lot of respect in the industry, and they propose, to the DP, a special rate including special credit and higher remuneration. Two of these offers are selected.

There are now thousands of hours of footage to be sorted through. First, in addition to basic metadata such as time, date and location, each cameraman should add some metadata to the footage. This is able to be unstructured text that is able to be parsed by intelligent text parsing engines. When possible the data should also include things such as the name of the event filmed and the names of the participants if available.

### The Footage Repository:

An issue is how to sort through this huge mass of footage? To clarify the series of possible steps, FIG. 11, the Footage Repository, is shown.

The footage is posted to a private area called the Footage Repository (1102) which is under the control of the Documentary Production Entity. Though the footage itself could be on servers anywhere as provided by cloud based hosting services, the control of access to the footage itself and the associated metadata requires permissions—typically certificates as provided by the E-Contracts (1011). The individual cameramen are given access to the footage they have posted, but once they have completed the transaction of licensing to the Production Entity, they may no longer control the copy in the Footage Repository which is now under the control of the Documentary Production Entity. In some embodiments, the Footage Repository is not under control of the Production Entity but rather, the Production Entity is able to exercise control. For example, the files are stored in a commercial cloud, but they are encrypted, and when someone wants access to footage, that person has to present his/her credentials, and then access is granted.

The participants of the Agora (1103, 1105) are used to curate the content. This “Crowd Curation” functions on multiple levels. First, there are multiple axes: 1) How on topic is it? 2) How good are the performances in the video? A great speech with less than optimal lighting or color balance is better than a boring speech that is well lit. 3) How is the quality of the shot (light, composition, contrast, focus)? This could be multiple different choices or it could be one (probably, one with sub-choices if the reviewers want to drill down). 4) How is the audio?

The value of each reviewer is rated. High on the list are the cameramen who shot the footage. They know what the expectations are, they know about footage, and they know the subject. The value of other recommenders is weighted based on their expertise and success. Actors are more highly rated when it comes to the quality of individual performances. Directors and Producers are more highly rated when it comes to overall value to the project. Audio engineers are more highly rated when it comes to sound quality. The general audience of Anonymous Reviewers (1107) is best when it comes to guessing what will be a popular scene. In general, but particularly with regard to the Anonymous Reviewers, passive data is able to be used as well as the explicit review data listed above. For example, if a clip is not watched all the way through, it would be rated lower than one that was watched all the way through. Also clips that are watched multiple times are rated higher. If a section of a clip was watched multiple times, that section is able to be flagged and rated higher than if it was not.

Returning to the Identified reviewers, their reputation relevant metadata (1105) is placed in the Reputation Information Database (1104). This database feeds the Reputation Engine (1106) which is also fed by the Anonymous Reviewer Data (1107). Each individual in each sub-group is individually rated based on their historic accuracy. So for example, if a reviewer used the term riveting when referring to a performance, and in all those cases the performance made the final cut, that means that their reputation with regard to performance quality is high (and vice versa). Additionally, if a reviewer (registered as opposed to anonymous) has good credits, they are rated higher. For example, a cameraman who has worked on multiple academy award winning films is naturally rated higher than someone who has never worked professionally. Also if someone has awards (e.g., nominations for a Golden Globe), that increases their reputation index. Finally, if someone has been mentioned positively in blog posts or published reviews, that also increases their reputation index—more for a major review like in a trade magazine and less for a casual blogger.

When the Director of Photography (1112) or others with the appropriate permissions log in to the Footage repository, they do it through a dashboard that is informed by a Multi-Axis Stack Ranking of Clips (1109) which is in turn informed by Clip Metadata Parser (1108) and the Reputation Engine (1106) which all use data captured from the Reputation Information Database (1104) and the Footage repository (1102). The Multi-Axis Stack Ranking of Clips module ranks the clips based on how high they are on different axes. For example, if a user is looking for an emotional moment with good audio that is a close up on a face, those parameters could be raised on the Ranking Dashboard and the proximity by date and time to the previous clip might be de-prioritized. However, for another clip, such as further shots of the crowd at a specific event, the audio might be unimportant (different audio could be used later) but the time of day (e.g. brightness, sun position) could be raised higher in the Ranking Dashboard.

### The Reality Agora:

Reality shows are typically based on a concept, frequently with “talent” (the personalities or actors) attached. In the Reality Agora, concepts could be posted in an “open call” to personalities. For example, chefs might apply to a new concept for a cooking show. The community might express their opinions on the concept and the talent and the combination. Based on the perceived value of the talent, an offer might be made. It could be a financial guarantee or a percentage of participation or both or neither. Once the concept and the talent have established their legal relationship, the new talent-attached proposal is able to be shopped around or is able to be filmed in a sizzle or demonstration reel that is able to then be put out to the community for review or sent directly to distributors for further negotiation.

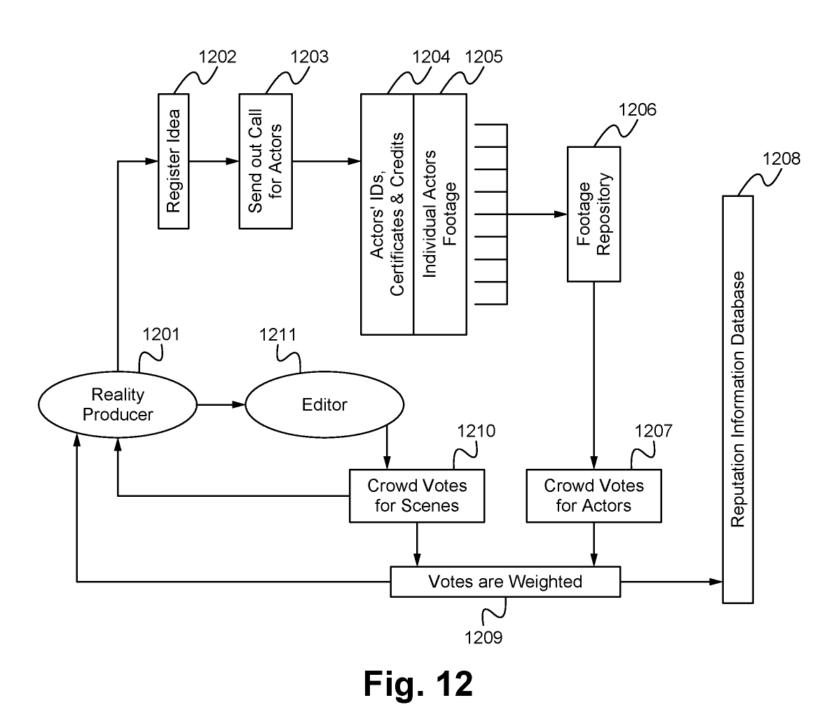

A more social approach is shown in FIG. 12 (Reality Agora). In this example, the majority of the show is able to be created in a network-connected social environment. First, the Reality Producer (1201) registers her idea (1202) and sends out a call for actors (1203). Actors read the proposal (or whatever portion of the proposal is made public) and register with the project (1204) as was demonstrated previously in FIG. 7. By signing their registration they agree to a click license (E-Contract). The Actors then upload their footage to the Footage repository (1206) as test footage (that is, they may not necessarily have the rights to use this footage commercially). Now the set of registered industry users (actors, cameramen, writers) and optionally the additional set of all registered users (e.g. not in the industry but like to watch and vote) express their opinions rating the footage of the various actors (1207). The opinions are weighted using the Reputation Information Database (1208) and are stack ranked and sent to the Producer (1201).

This process is able to be used to find potential Reality Actors, and they are able to be contacted, and E-Offers are able to be made.

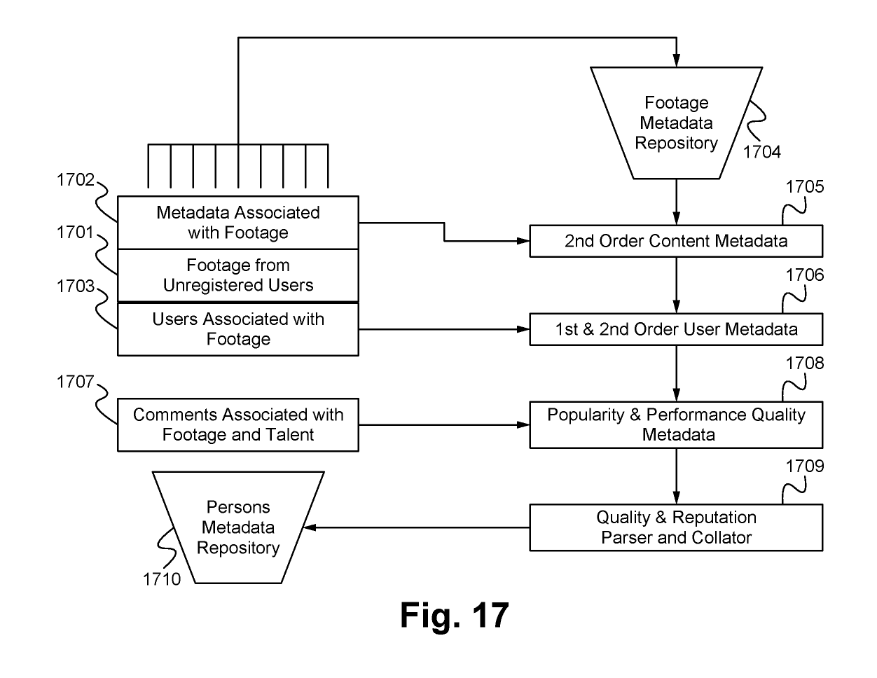

Using a different approach, the Actors and scenes selected by the crowd, and the Producer is able to be sent to an Editor (1211) who, in collaboration with the producer and other professionals (e.g. Reality Writers) are able to put together one or more vignettes that are then sent back into the Reality Agora where the crowd (1212) votes on Scenes. These scenes could also be sent to an Editor Agora where as in FIG. 17, a crowd of Editors could do different edits, and the crowd could vote on them. This whole process is able to be an iterative loop where different versions keep going back to the crowd and to Editors for further iterations until the producer feels it is ready for publication. Alternatively, the content could stay in the loop indefinitely drawing viewership and advertising dollars to multiple different versions.

### The Agency Agora:

In today's world of filmed entertainment, talent of all kinds is represented by an Agent or an Agency. How does an Agency find the talent to represent? Today, it is typically by word of mouth. Agencies cannot take unsolicited tapes of actors, writers, or directors because they would be inundated and be unable to cut through the noise. However, if an agency had access to the ratings of the talent pool as measured by their peers and by others of some repute; they could make better informed decisions. As noted above, the value of each recommendation could be weighted based on the track record of the reviewer. So, for example a successful Director or Show-Runner's opinion of an actor might be given a higher value than a Cameraman who had never worked on a professional project.

An Agency might also have a dashboard where they could adjust the parameters, for example, weighting professional actors more heavily in one view and directors of photography in another view. They might weight comedy writers more heavily when looking for one kind of actor and drama writers more when looking for another kind of actor.

To clarify the way this works, refer to Diagram 13. The process begins with an Agency (1301). An Agency is always looking for new and established talent. There are two distinct pools of talent. 1) Professional Talent (1302): those members of the community who have worked on professional films and videos and are rated by their peers and by their credits. 2) Amateur Talent (1303): these are people who either a) want to become professional and have not yet had the opportunity or b) pure amateurs who do this simply for the personal enjoyment and the pleasure of their social network. The reputation engines for the two groups of talent work differently. The professional Reputation Engine works as it does in FIG. 8. The Amateur recommendation engine works a bit differently. Because the Amateur Reputation Engine does not have the breadth of accountability of the professional reviewers it works mostly by inference. If scenes that are paused on or repeated have close ups, that implies that the actor in the scene is better. Close ups are more about the actors. Long dialog is more about the writer. Long shots are more about the cinematography. In general, for the amateur, popularity is the highest value.

### The Legal Agora:

For many arrangements in the Agora, there will be an electronic offer made, and a participant is able to either accept or reject. However, sometimes more detail and nuance is required. There can not only be recommendations for both sides of a negotiation, but there are able to also be recommendations for legal counsel. Counsel could be paid directly (billed with or without a retainer) or counsel could agree to a revenue participation for a portion of the clients revenue or some combination of both.

There is a broad range of appropriate legal effort required depending on the deal. Just like today, there are able to be all ranges of effort required in negotiation and all levels of expertise and negotiating ability. Lawyers in the Legal Agora should be transparent in both their pricing and their capabilities.

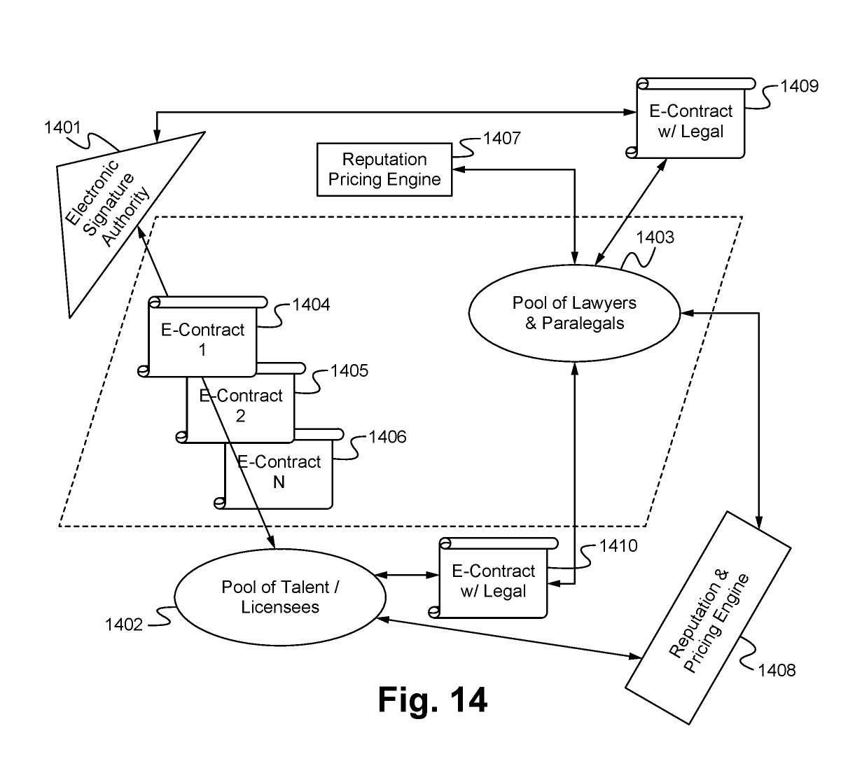

FIG. 14 shows the steps required to take advantage of the Legal Agora. A Production

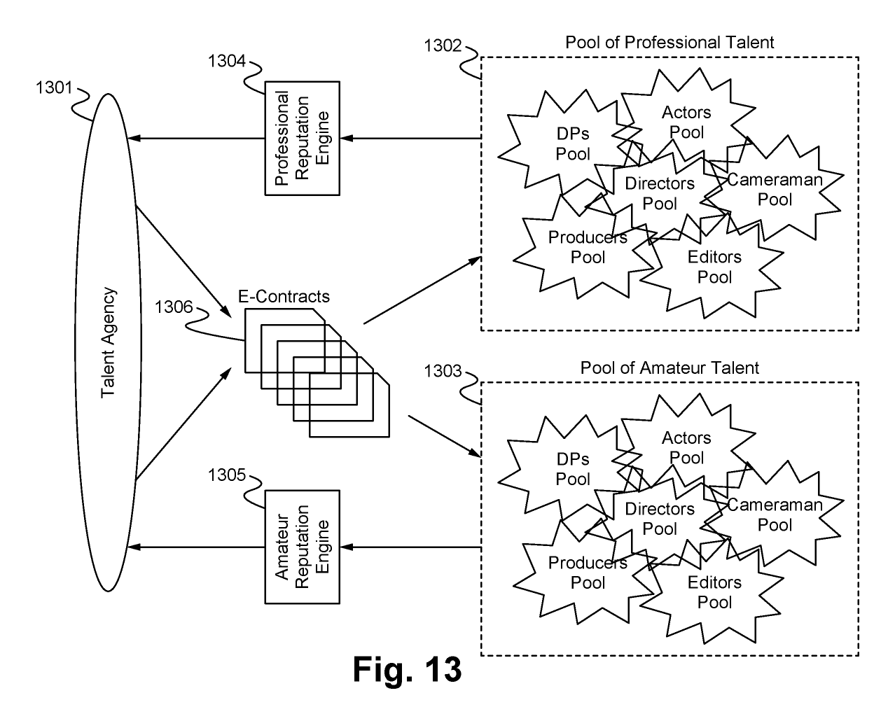

Entity (1401) wants to utilize some talent (e.g. an Actor, Director, Cameraman) from the various pools of talent (1402). They need a Lawyer (1403) to negotiate on their behalf and so, using the Reputation Engine (1407) they choose one. The Reputation and Pricing Engine works similarly to the Reputation Engines in FIGS. 7, 8, 11, 12 and 13. Included in this diagram is also the concept of adding Pricing information to the engine. This is able to be found in the Metadata associated with any negotiating entity and either the type of pricing (from pro-bono to hourly to a percentage of revenue) or the amounts are able to be exposed. Once a Lawyer is chosen, they both digitally sign the E-Contract (1409). A mirror of that behavior happens between the Talent (1402) and their Legal Counsel (1403) using the Reputation and pricing Engine (1408) and signing an E-Contract (1410). The Lawyers representing the Talent and the Production Entity are able to negotiate their E-Contracts (1404, 1405, 1406).

### The Filming:

Producers, Associate Producers, Executive Producers are all part of the business and coordination portion of making a commercial film or TV show.

Filming is generally in a hierarchy. In the US, at least, the technical crew is subordinate to the Director of Photography (DP) who, along with and next to the Director, has the final word on all decisions related to both lighting and framing, color and tone. The DP selects the Camera Operators. Camera Operators sometime evolve into Directors of Photography. In the Agora, Camera Operators (as in the real world) might accept less money for the opportunity to be a DP to advance her career. However, in the Agora, Camera Operators might have the opportunity to select low budget films to work on and find opportunities to which they would never have been exposed in a purely manual world. When a DP is looking for Camera Operators, they could use the Agora and recommendation and filtering to review the work of hundreds or thousands of Camera Operators to narrow the field.

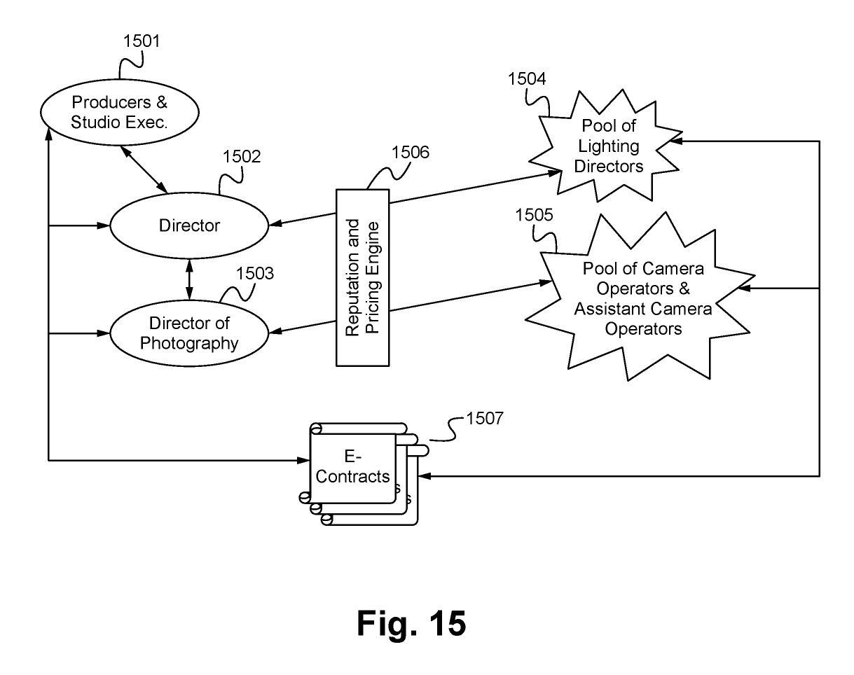

FIG. 15 demonstrates how this process is able to work. For this example, it is assumed the Producers/Studio Executives (1501) have already selected a Director (1502) and the Director has selected a Director of Photography (DP). They could have used the Agora and the Reputation Engine for that process. The DP now leads the process for finding Camera Operators (1505). The DP queries the Camera Operator's Agora looking for Camera Operators available on the proposed filming dates. The DP will optimize the search by setting parameters to be used by the Reputation Engine like a minimal score on the reliability index, a minimal score on the experience index (perhaps separate numbers for Film and for TV and for Internet), perhaps someone who has worked with some of the actors expected, high scores on filming in populous cities. Perhaps the Actors, the Director and the Producers are also entered hierarchically with the most important ones at the top to see what the rating would be based on their Reputation Score of the Camera Operator. Similar to FIG. 8, Reputations and Recommendations are able to be de-referenced by 1, 2, 3 or more degrees of separation. Reviewers who are 3 degrees of separation away will be weighted lower than those who are 2 degrees away and higher than those who are 4 degrees away.

In a similar factor, the Director (along with the DP) selects the Lighting Director from the Pool of Lighting Directors (1504) using the Reputation Engine (1506).

Just as there is a hierarchy for DPs and Camera Operators so there is also a hierarchy for Directors Assistant Directors (ADs), 2nd ADs, 3rd ADs, Production Assistants, Line Producers. These are able to all be selected or placed in a pool of possible choices using the mechanisms listed above.

### The Special Effects:

Special Effects are becoming easier and easier to provide. Initially, effects were done manually (hand painting on top of frames of film). Gradually it has become more automated but still usually requires a large infrastructure where effects workers have to be proximate to all the processing power and effects tools. This technology will move to the cloud and with it, the requirements of colocation will go away. Once there is an environment where workers, time spent working and location of resources are all fungible, it will be possible to farm out effects as “piece work.” Recommendation and reputation are important for choosing writers, and added transparency creates accountability. The same thing will happen to Special Effects workers. For example, there is a software program that specializes in removing wires from scenes where they were used to suspend actors. Special Effects workers would list this as a specialty that they have, and the recommendation engine would advise who the best hires were. People are able to break into the field by low pricing and money-back guarantees. Other more experiences workers might guarantee fast turn-around or the ability to work in higher resolutions or on trickier scenes.

In the hierarchy of Special Effects, there is a Special Effects Coordinator who typically manages all the workers and software. They might logically be the person to take advantage of the Effects Agora but they might be chosen by the Director or Producer using the same Agora just focused on management and coordination skills and experience as well as the other metrics.

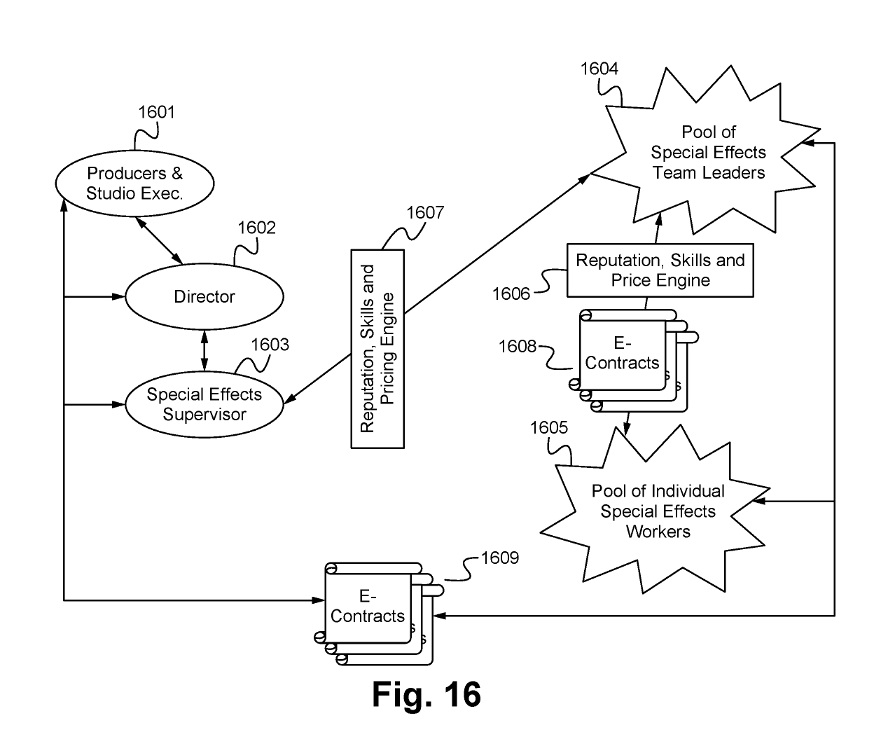

FIG. 16 illustrates the Special Effects Agora. The Director (1602), possibly in coordination with the Producers and/or Studio Executives (1601), chooses a Special Effects Supervisor (1603). This process could be effectuated using E-Contracts, Reputation/Recommendation Engines and the same kind of Agora possibilities as with other workers on the production. In FIG. 16, Visual Effects are the focus. As with other groups of workers, this is somewhat hierarchical. Though there are many possible hierarchies, the method described herein does not specify the hierarchy and is able to support any kind of hierarchy; the one listed here is just for purposes of example. Typically, a Visual Effects (VFX) Supervisor might work with a number of Facility Computer Graphics (CG) Supervisors and Facility VFX Supervisors. They will, in turn work with Production Managers and Production Coordinators (1604) who will, with them also work with Lead Technical Directors, Technical Directors, Lead Compositors and Compositors (1605). As the hierarchies are not fixed, the system should be very flexible with regard to the capabilities of VFX workers.

Additionally, there is another axis on which this pivots and that it which teams have worked together. The Reputation, Skills and Pricing Engines (1606 & 1607) should track, in addition to the lists of skills, the historical record of what other workers each worker has worked with and the dates of those engagements. This is able to then be used to help in assembling teams and even, based on the outcomes of the individual projects, be used to avoid certain combinations.

There is one more axis on which this pivots, and that is pricing of worker's salaries. There is a set of expected salary levels that is able to be informed by locale (e.g., Rajasthan might be cheaper than Manhattan) and by years of experience, type of experience. Additionally, if the worker has a history working for this Production Entity, there are able to be historic salary levels.

As with other kinds of workers, salaries and terms of employment are able to be negotiated manually, but they are able to also be negotiated or finalized using E-Contracts (which being part of the same system would easily feed back into the Reputation, Skills and Pricing Engines (1606 & 1607).

### The Editing:

Consumer editing tools are already quite robust and will soon surpass the professional tools of the last decade. How does editing benefit from the “Agora Effect?” Certainly, it will be important for the Director to be in close proximity to the Editor. Physical proximity will be partially replaced by virtual proximity. Certainly, edits will be cached in the cloud in real time and Directors will have access to them in real time. Also editing is subject to piece work just as Effects are subject to piece work. There is nothing stopping an Editor from farming out a car race to one or more Editors who the reputation engine says are quite good at car races. The Senior Editor could then cut them together. These editors could all be paid by the hour (the software monitoring their time), or they could be paid on “amount of frames used” basis where they get paid based on how many frames are actually used in the final cut. Perhaps, their frames have to be purchased within a prescribed period (e.g. 48 hours), and the Senior Editor might “buy” multiple versions and finalize the decision later.

It should be reasonably clear how to, taking into consideration the language above about how an Editing Arora would work, map the Reputation/Recommendation Engines, E-Contracts and the general principles of the various Agoras above (Writing, Filming, Visual Effects) to an Editing Agora, and so no Editing-specific diagram is needed.

### The Amateur Agora:

Many video-based titles are created today by amateurs. Some are short clips of their children or pets or pranks. However, as the tools of creation become democratized, higher and higher quality content will be created by non-professionals. Millions of hours of video are being created every hour. Most of this video is of limited interest to most consumers. Occasionally, a video becomes very popular having millions of views in a very short period of time. This viral recommendation effect is currently applied to short snack-sized media but as the quality improves, longer forms will also become popular.

FIG. 17 shows how data about media and participants both on the creation and consumption side is able to be gathered. Looking at the cumulative collection of all the video footage that is posted on the web, there are many sources, and there will be more. Currently there are YouTube, Dailymotion, Metacafe, Vimeo, Youku and dozens of other smaller providers. These will only increase in number and scale. 1701 represents the collective footage of all crawlable video services. The actual video is not collected, only the references (URLs) to it. 1702 is the metadata associated with those videos. Some sites collect more data than others and some sites allow 3rd party access to more data than others. Also some sites could have business relationships with third parties to allow greater access to metadata. The data in 1702 is associated with the video represented by 1701. All of this data (the URLs in 1701 and the additional data in 1702) is stored in a Footage Metadata repository. 2nd order metadata (1705) like the order of videos watched or the profiles of the people watching the videos or the data associated with other content that is similarly tagged is collected. Next, 1st and 2nd order User Data (1706) is added to the mix. This includes data such as: what videos are my friends watching, what videos are the friends of my friends watching, what are the comments about the videos (e.g. she was so riveting I couldn't take my eyes off of her, or I am very impressed with the cinematography or I hate the lighting or the costumes were awesome). This data is collected from social networks, blog posts and other public fora (1707). This is then added to the Popularity and Performance Quality Metadata (1708) along with the basic usage like number of views, location of viewers, time of day of viewing, how much was each video viewed (e.g., did many people stop after 1 minute, how many people watched it multiple times, what part of the video was watched most often).

This data is then all collected and stored in a scalable parsable form (1710) so that the talent acquisition entities (Directors, Production Companies, Editors) are able to use this data to search for talent.

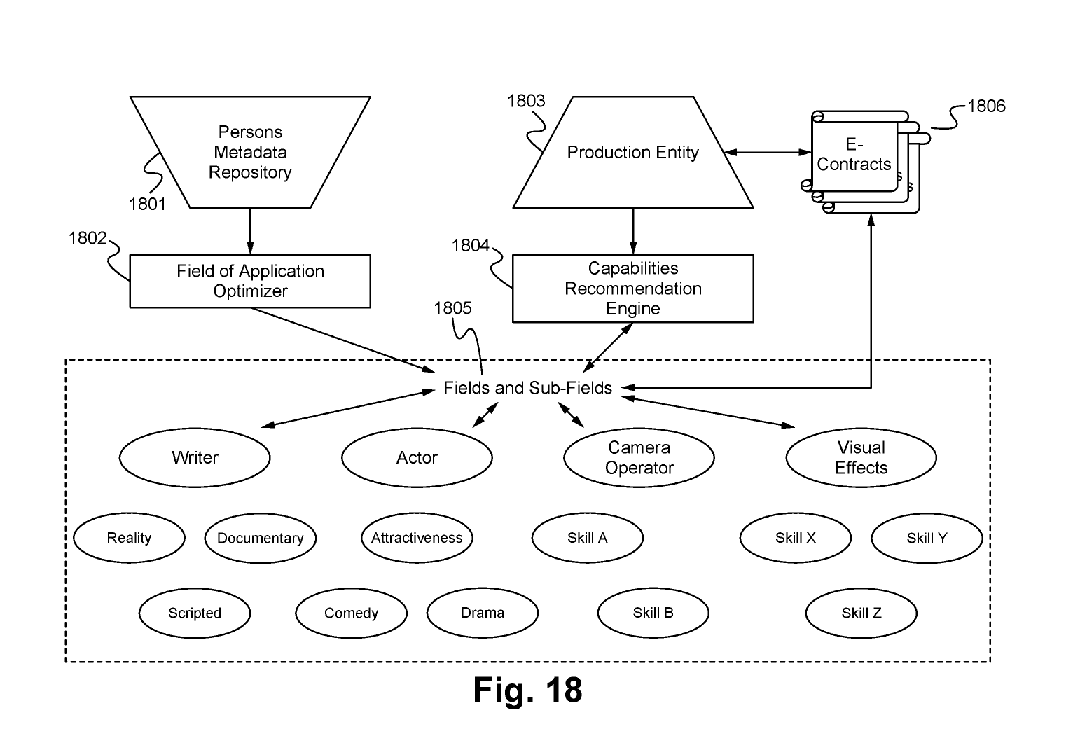

FIG. 18 shows how the Amateur Agora is able to be used for Finding Talent. The figure begins with the Person's Metadata Repository (1801) which was carried over from FIG. 17. This contains all the metadata about potential talent which was gleaned from the Amateur Agora. This metadata is acted on by the Field of Application Optimizer (1802) which takes all of the metadata and associates it with its relevance to selected tasks. For example if social networks indicate that a particular video was very well written and indications are also that the writer was Individual A, then Individual A is associated with the Writer Field and given the appropriate reputation. If it is a Comedy, it would be particularly associated with the subfield of Comedy. Note that the Fields and Sub-fields (1805) are not shown here to be exhaustive but are representative of some of the Fields and Sub-Fields.

When a Production Entity (1803) is looking for a certain type of talent (e.g. a writer or a Director of Photography), they make their request through the Capabilities Recommendation Engine (1804) which parses the Fields and Sub-Fields for talent which has been tagged with the metadata from the Field of Application Optimizer. The Capabilities Recommendation Engine then returns relevant choices for talent to the Production Entity which is able to then propose E-Offers to the Talent from their store of E-Contracts (1806).

Based on the monitoring of granular consumption behavior many things are able to be learned.

For example:

### Bell Weather Consumers:

Popular fads and media often have a curve of adoption. They may not be popular when they are first released but they become more popular as time goes on. When there is a large set of consumers whose consumption choices are tracked over time, there will be some consumers who are early adopters. Imagine that “Show A” becomes popular in December even though it was released in September. By seeing which consumers were watching this show in September, a class of consumers has been created who may have been predictors of success. A consumer watching a show early does not tell much but thousands of consumers (out of the millions or billions of consumers followed) who consistently watch a particular class of video assets early could be an accurate predictor. This will likely be optimized by granular tracking so, for example, there might be 3,000 comedian predictors who have watched comedians numerous times 3 months before they became popular. The unknown comedians these Comedian Predictors are just beginning to watch today have a significantly higher probability of becoming successful in the future than the general category of comedians. A digital agency could use Bell Weather consumer data to find new talent.

There are able to also be very near term Bell Weather effects. Some of the media success predictors could have a very short lead time. For example, there are people who start the trend by sharing with their circle of friends. These might often be people with a lot of virtual friends (people Stanley Milgram who referred to people like this as connectors in the original Small World experiments). In cases where the popularity growth is very fast, an agent or studio might need to act quickly to be the first to establish a relationship with the creator. There may be business opportunities that are available early in the trajectory—perhaps booking a slot on a TV talk show or arranging for theatrical distribution while the buzz is still growing; perhaps doing sub-titles or foreign language translations to create a more global phenomenon. Algorithms are able to be tuned to be triggered based on who watches and in what time period including location information and demographic information about the watcher, time of day, or other information. The algorithms are able to then be used to generate automatic contacts to the appropriate people so that they are able to respond very quickly. For example, a music video could trigger someone who would want to manage or book the artist or sign them to a music distribution deal. Having access to the data will enable business to see opportunities early and respond effectively.

### Granular Skill Prediction:

The consumer Agora is filled with both implicit and explicit metadata. One form of explicit metadata is commentary. Parsing the commentary on a particular performance in an amateur video is able to inform opinions about the talent associated with that video. For example if a video has a lot of comments about the quality of the filming or the quality of the acting or the quality of the writing, those comments imply that that particular aspect of the production may be worth further investigation. Further, the value of those comments are able to be weighted of based on the historical value of the person doing the recommendation. So, for example, if a large percentage of lighting directors say that a video looks nice, an algorithm could imply that the lighting is well done. However, this does not have to be limited to lighting directors. Classes of lighting-sensitive-viewers are able to be created based on their historical likes, and this data is able to improve in accuracy over time. If a user starts with a virtual expert system based on the likes of professional lighting directors—weighting the opinions of those who worked on successful films above those who did not using a sliding scale so, for example academy award winning lighting directors would be higher in the rating than lighting directors who worked on popular titles and they would be higher in rating that those who worked professionally but never on a successful title. The user uses this subset “lighting intelligent consumers” to make decisions about which amateur videos are probably well lit. The user is able to also track the consumers whose opinions track with these experts. These people are called “lighting sensitive consumers.” The user is able to track all these lighting intelligent and lighting sensitive people over time and see how they do as individuals against the lighting awards within the industry and then adjust the weighting of these individuals based on their historical track record.

This same mechanism is able to be used to track all classes of talent; predicting the next talented actor or director or special effect supervisor—even from the masses of amateurs.

### The Video and Film Agora:

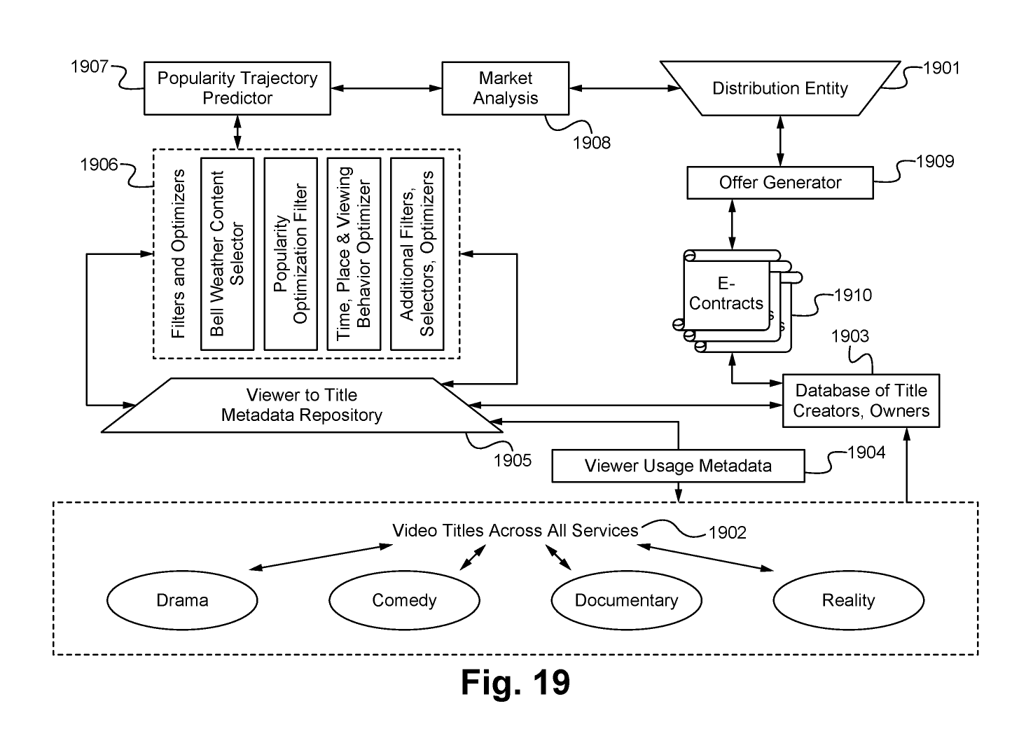

There is one further way to use the collective wisdom of the Agora, and that is to find finished videos that may be ready or near ready for distribution. This mostly relies on the viewing habits of the masses though it may be optimized by weighting from a Reputation Engine. The process involved is able to be seen in FIG. 19.

A Distribution Entity like a Studio, TV Network, Theatre Owner or other type of Distributor (1901) is looking for Videos and Films that it is able to distribute to Theaters, Television Channels and Online Aggregators. Metadata is collected from across all available online services (1902).

There are multiple sources of metadata. First is the metadata from the various Public Video Services (1902). This includes the metadata of Titles, and Creators and/or Owners and the Viewer Usage Metadata (1904) collected from the various services. There are multiple ways the Viewer Usage Metadata is able to be acquired. One way is using an API (Application Programming Interface) to log in to the data made available by the different Video Aggregators. There are two potential difficulties with getting this data. 1) is that there are liable to be privacy issues, and these need to be very carefully managed based on the privacy policies of the various Video Aggregators and it may be necessary to abstract away some of the User Metadata. User data may still be found by cross referencing against other User Metadata that the Distribution Entity has acquired from other sources. 2) The Distribution Entities will not want to share the richest set of data that they have, and, invariably, a business relationship (partial joint ownership, licensing) will be needed to have access to some of the data.

Since the Distribution Entity participates in the various repositories described above (Editors, Directors, Producers, Actors, Special Effects Supervisors), it will have access to a rich set of data about the creators of many of the titles across the services. This Database of Title Creators and Owners (1903) is associated with the Videos across All Services (1902) and, along with the Viewer Usage Metadata is stored in the Viewer to Title Metadata Repository (1905). Once there is a repository of Title Data, Creator Data and User Data collected from all of these sources (1905), it is important to Filter it and Optimize it (1906) so that it is able to be used effectively. Some of these filters include:

1) A Bell Weather Content Selector: This, as mentioned above, is a mechanism that collects viewers who have a history of being good judges of talent that will later become popular and uses their taste as a predictor of future success.

2) Popularity Optimization Filter: Titles cannot be judged just solely by how popular they are. The Distribution Entity is usually not interested in videos of pets or kids pulling pranks (except in cases like documentary aggregation). Beyond basic optimizations for content, there are optimizations for audience profile. Viewers who like police procedurals are a better judge of the value of a police procedural. Titles more popular with women may be more relevant in certain situations. Titles that are longer (e.g., over 20 minutes) indicate a relevance to TV viewing. Titles that are viewed multiple times are better. Titles that are often paused in a particular place may indicate special aspects of a scene that might need more clarity because it is confusing or might want to be repeated or varied because it is so popular. All aspects of granular parsing of popularity metrics and user profiles may be relevant.

3) Time, Place & Viewing Behavior Optimizer: Titles may be more relevant in different territories. Titles that are viewed in the evening may be more relevant for traditional TV viewing or may be better targeted at Evening TV viewers as opposed to Daytime TV Viewers.

4) Additional Filters, Selectors & Optimizers: There may be a plethora of other filters and optimizers. One example is seasonality of different slices of viewers or of different types of content. Another example is pace. Titles with faster cuts or different rhythms of cutting may appeal to certain viewers (e.g., faster cuts probably skew younger). Percentage of Close-ups compared to long shots is another metric. Also locale is a metric, e.g., on the water, in a big city, in the desert or more specifically in New York City or Phoenix Ariz. or Paris. Yet another is the make-up of the cast: is it mostly women, more attractive women, large women, fashionable women, burley men, teens, young children, animation of many different types.

Tying the consumer behavior to the details of the production will create data which is able to be used to make qualitative and quantitative decisions about distribution options. All of the above data is able to be stored and parsed by the Popularity Trajectory Predictor (1906). The Distribution Entity uses this Predictor to make educated guesses about what titles might be popular with which audiences.

A Market Analysis (1908) is done for each prospective title. This Analysis is used to determine the likely projected revenue for each title or group of titles. For example, if Title A was on trajectory X and previous titles with the same Trajectory have generated M dollars, that is able to provide a reasonable guess as to the value of the title being analyzed. Though each title will likely not follow the predicted trajectory, taken as a whole, the collection of a significant number of titles will, in the aggregate, follow that trajectory. The Popularity Trajectory Predictor (1907) will learn over time fine tuning its algorithms as it learns from an ever increasing set of experience data.

Once there is the set of titles, a Distribution Entity may want to license for further distribution, the list of Owners and Creators whose permission is needed in order to distribute and a proposed revenue projection, the Offer Generator is able to generate E-Contracts, and they are able to be sent to the various licensors, In some cases, the Offer may be best served using human interaction, and various negotiating entities are able to be notified to make the Offers.

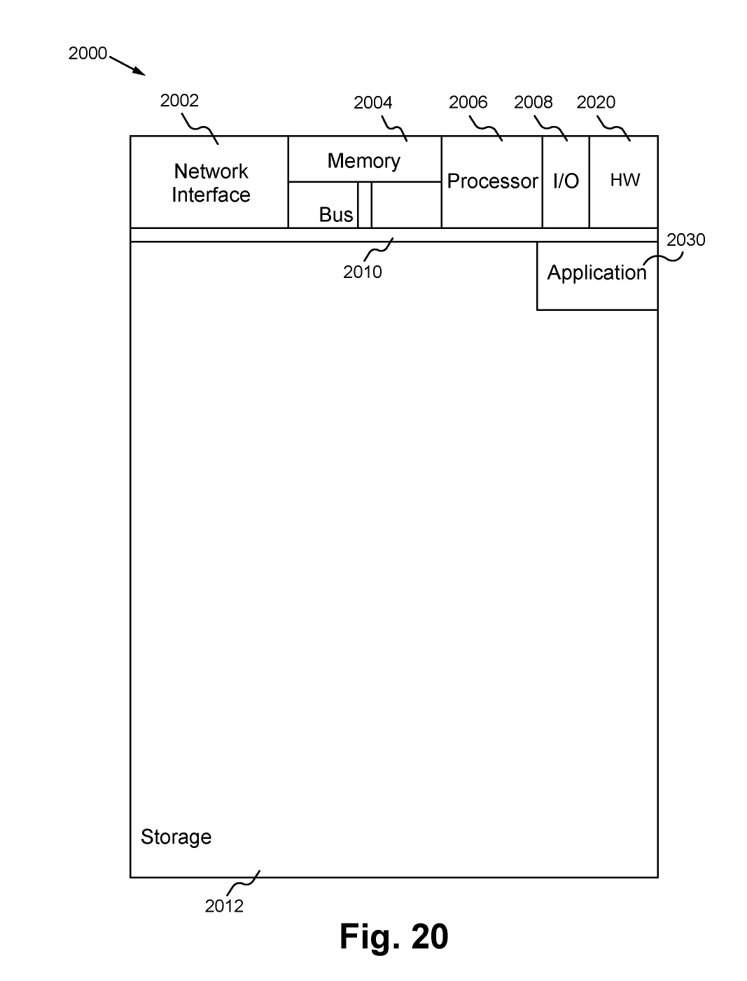

FIG. 20 illustrates a block diagram of an exemplary computing device configured to implement the video development method according to some embodiments. The computing device 2000 is able to be used to acquire, store, compute, process, communicate and/or display information such as images and videos. In general, a hardware structure suitable for implementing the computing device 2000 includes a network interface 2002, a memory 2004, a processor 2006, I/O device(s) 2008, a bus 2010 and a storage device 2012. The choice of processor is not critical as long as a suitable processor with sufficient speed is chosen. The memory 2004 is able to be any conventional computer memory known in the art. The storage device 2012 is able to include a hard drive, CDROM, CDRW, DVD, DVDRW, High Definition disc/drive, ultra-HD drive, flash memory card or any other storage device. The computing device 2000 is able to include one or more network interfaces 2002. An example of a network interface includes a network card connected to an Ethernet or other type of LAN. The I/O device(s) 2008 are able to include one or more of the following: keyboard, mouse, monitor, screen, printer, modem, touchscreen, button interface and other devices. Video development application(s) 2030 used to perform the video development method are likely to be stored in the storage device 2012 and memory 2004 and processed as applications are typically processed. More or fewer components shown in FIG. 20 are able to be included in the computing device 2000. In some embodiments, video development hardware 2020 is included. Although the computing device 2000 in FIG. 20 includes applications 2030 and hardware 2020 for the video development method, the video development method is able to be implemented on a computing device in hardware, firmware, software or any combination thereof. For example, in some embodiments, the video development applications 2030 are programmed in a memory and executed using a processor. In another example, in some embodiments, the video development hardware 2020 is programmed hardware logic including gates specifically designed to implement the video development method.

In some embodiments, the video development application(s) 2030 include several applications and/or modules. In some embodiments, modules include one or more sub-modules as well. In some embodiments, fewer or additional modules are able to be included.

In some embodiments, the computing device 2000 is able to implement other methods/systems as well such as a reputation engine and/or other reputation analysis.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, an augmented reality device, a virtual reality device, a home entertainment system, smart jewelry (e.g., smart watch) or any other suitable computing device.

To utilize the video development method, a device such as a computer or mobile phone is able to be used to communicate via the Virtual Agora. Any of the steps described herein are able to be implemented manually, automatically by a computer or a combination thereof.

In operation, the video development method enables users from across the world to collaborate to produce high quality work.

The reputation analysis method is broken into a number of serial and parallel processes. There are both Granular Reputation Engines and Iconic Reputation Engines. Both are able to be further divided based upon whether the person or entity making or implying the recommendation has 1) explicitly identified themselves and has a profile, 2) has implicitly identified themselves (e.g. they are tracked using cookie-like mechanisms) and there is some behavioral data or 3) they are completely anonymous.

The general principles of reputation and recommendation to the entertainment industry are applied, although other principles are able to be applied. Work exists in the marketplace around reputation and recommendation in some verticals such as travel, apartment rental and transport services. However, those environments are somewhat narrow and other fields (such as the creation and distribution of entertainment), being broader, will naturally require techniques that a) cover a much more detailed level of reputation and recommendation pivoting on a number of axes and b) will have a more generalized algorithmic approach which is able to be applied more broadly.

### General Reputation Engine Architecture:

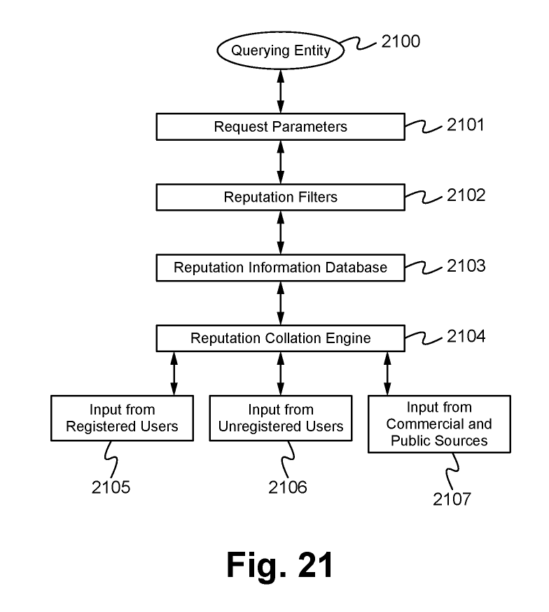

The architecture for Reputation and Recommendation is shown in FIG. 21. Beginning with the Querying Entity (2100), a query containing Request Parameters (2101) is made for a specific kind of resource. In Media Creation, this might typically be a Producer looking for a Director of Photography (a DP) or a DP looking for a Camera Operator or a Producer looking for an Actor or a Screenwriter. As mentioned above, this same approach could apply to any other field. For example, this might apply to investment service professionals who could be broken down into stock advisors or bond advisors or retirement specialists. Those areas are able to be further subdivided so, for example, Stock Market Specialists could be broken into people who specialize in the verticals of Energy or Banking or Consumer Electronics.

Returning to FIG. 21, the Request Parameters (2101) are used to select which Reputation Filters (2102) are applied and in what way as they query the Reputation Information Database (2103). The Reputation Information Database will have been populated in great detail by the Reputation Collation Engine which, in turn, received its input from multiple sets of data: 1) from Registered Users, 2) from Unregistered Users and 3) from Public Sources and Commercial Sources.

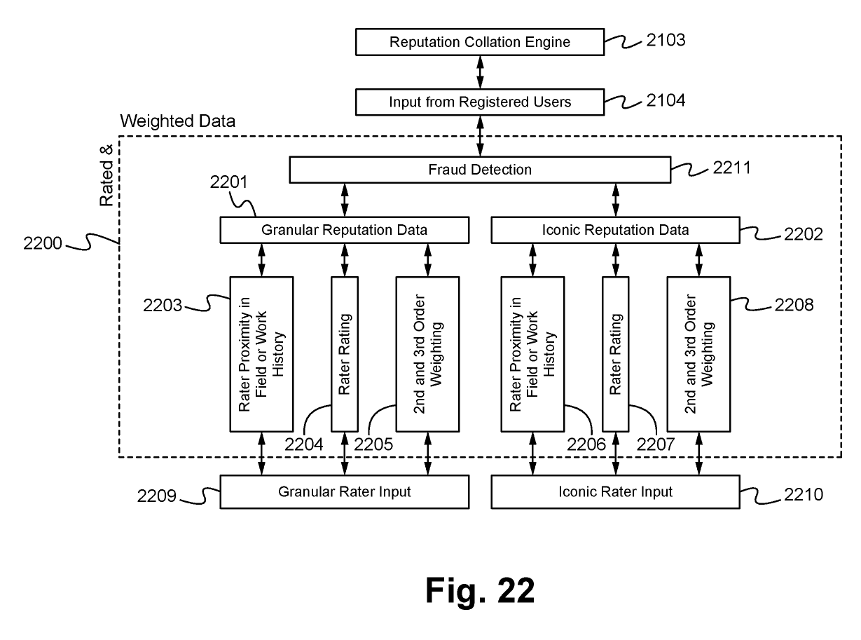

A more detailed view of the gathering of Reputation Data is able to be seen in FIG. 22. FIG. 22 shows the Reputation Collation Engine (2103) is fed by input from Registered Users (2104) which is fed by the Rated and Weighted Data (2200) which is broken into two buckets: 1) Granular Reputation Data (2201) and 2) Iconic Reputation Data (2202). Granular Reputation Data (2201) is generated when the rater (the one doing the rating) gives specific information about the ratee (the one being rated) on any number of axes using from one to many possible domains of rating (e.g., Camera Operator, Actor, as mentioned above). Iconic Reputation Data is typically of a more generalized nature. In cases where the rater may not want to spend the time or effort to give detailed feedback, they are able to use the iconic representation of “Thumbs Up,” or “Like,” “Thumbs Down” or “Dislike” or “Thumbs Neutral,” to express how they feel about a particular element from the general (in Media that might be a film or TV show) to more specific (e.g., an Actor, a Director, the lighting, the Visual Effects).

Granular Reputation Data from Registered Users:

There are many axes around which reputation is able to revolve. Just as a restaurant reviewer might scale a restaurant on the quality of food and the quality of the service and the price, similarly, participants in a Virtual Marketplace will receive reputation scores on different axes from different people that they have worked with. Furthermore, because different capabilities and different aspects of those capabilities are reviewed, much more nuanced and detailed input from recommenders is allowed. Some general areas to be indexed might be: promptness, reliability, honesty, ability to solve problems, respect from others and respect for others. There will also be granular details for each discipline. For example, Writers might be indexed on: commercial viability, comic dialog, dramatic dialog, scene description, plot development, character development for leading men, character development for leading women, and character development for supporting men. Visual Effects Workers would be indexed on different capabilities such as: the ability to paint out wires, the ability to create virtual camera angles, the ability to highlight shadows in low light environments, and rotoscoping ability. When reviewers rate others, there is no need to select all indices (many surveys require all questions to be answered but that is not the case here). As little as one comment on a participant's capabilities along one axis is still of value.

One additional factor to be included in the creation of the reputation indices is the weighting of the value of each recommendation with regard to a particular field of inquiry. As shown in FIG. 22, there are a number of factors that go into the Weighting the Rater and these fall generally into three groups: the Raters Proximity to the Ratee (2203), the rating of the rater (2204) and the 2nd and 3rd order value based on degrees of separation (2205) Taking these separately:

The first factor is proximity (2203). How close is the rater to the ratee organizationally? In the film industry, a relevance hierarchy is able to be determined based on the ontology described herein going both up and down. Recommendations from people working on the same project are significantly more relevant than those from people who are not working on that project. Slightly less relevant but still important are recommendations from people who have previously worked with the people they are recommending. Recommendations from people who have never worked with the people being rated have even less value. This axis of work history is applied to the hierarchy of the particular projects on which these people worked. However, there is still value to recommendations from people who have never worked directly with the people being who are being recommended. In general the following applies to all in the field. Recommendations from above are higher in value than from below (e.g. Lead Compositor is more relevant in judging a Facility VFX Supervisor then a Compositor). Also closer proximity is more valuable than further (for example, Assistant Location Manager is more relevant in judging a Location Manager than a Location Scout on the same project).

In building an engine for any field, similar ontologies are generated. Also, because relationships change over time, these ontologies should be enhanced, pruned and generally modified and tracked over time.

Recommendation weighting is also based on the rating of the recommender (2204). The rating of the rater is based on a number of factors. First, how successful are they? A rating from someone who has produced many hit TV shows carries more weight than someone just starting out. Or, if a reviewer, for example, a director, has a historical box office of multiple successful movies, his recommendation on the commercial viability of a writer would be weighted more heavily than an unknown director.

The reviewers are able to be rated on publicly available data like box office success and also on historical accuracy. So, for example, if a person who has reviewed hundreds of actors gives 10 new actors a high rating and those actors go on to be successful, that person's reviewer rating, with regard to selection of actors, will be high. More generally, it is tracked how accurately an individual's rating of a project or individual compare with the ultimate success or failure of that project or entity, and that historical data is used to increase or decrease the rating of the rater. If a rater rates others highly who later turn out to be successful or have a higher rating later; that implies that this rater is a good predictor of ability and such a rater should be weighted more heavily than the average rater. Conversely, a rater who turns out in retrospect to be a poor judge a quality will have the value of their ratings weighted lower by the weighting engine.

This is able to be extended to levels of indirection. 2nd and 3rd order rating (2205) has an impact on the rating of the rater. For example, if a person is highly rated by others, then their opinion (e.g., their value and weighting as a rater) is increased, and one who is rated poorly by others has their value and weighting as a rater decreased. This rater value loop is able to be taken to 3rd order value as well. If people who are rating workers in a particular field (say Camera Operator) are rated highly by people in that field, their rating of workers in that field is increased, but furthermore if they are rated highly by people who are rated highly by people in the field, this also has the effect of increasing their rating albeit by a diminished amount.

Because of the de-referencing of the Reputations (2205) and weighting based on degrees of separation, a reviewer's veracity is also generated with respect to specific areas of expertise. For example, if a user is looking for a Camera Operator who is particularly good at Long Shots, the user will start with those Camera Operators, among all the camera operators in the system (not just those who are available or local) who have been noted as good at Long Shots (the pool of Camera Operators will be smaller because many recommendations may be silent on that particular aspect) and see which of those have recommended Camera Operators in the pool of possible Camera Operators. This is able to be done expanding by a couple of degrees—that is not just those who have been recommended by people known to be good at long shots but also people who have been recommended by people who were recommended by people who are known to be good at long shots (2nd degree of separation). This would be weighted slightly lower than those who have recommended directly. Reviewers who are a 3rd degree of separation away are also able to be factored into the ratings of the Camera Operators but would be weighted a bit less than those reviewers who are separated by one degree or two degrees.

The temporal domain is also included such that the importance of each rating decreases over time. The rate of decrease is determined by a feedback loop which measures the accuracy of the rating based on the recentness of the proximity. The relevance of the rating is able to be decreased over time using, initially, a linear scale. As historical data is collected, that data is able to be used to determine the degree of linearity that was in fact found and if the historical data indicates that the relevance of the data as time passes should decrease more logarithmically, then the algorithm should be adjusted. A function, using the historical data, is generated based on the relevance of time in predicting the accuracy of the relevance. These functions should be separate for individual fields of expertise. For example, if it is determined that character actors, as a group, generally have the value of their rating decline very little over time but that the value of ratings for comedians declines very quickly, that should be reflected in the function/algorithm for each class and sub-class of worker or media type. Suppose the set of raters who worked with individual “A” on the most recent project (less than 3 months) are taken and compared with raters who worked with individual “A” 6 months ago and those who worked with them 12 months ago and 2 years ago and 3 years ago and 5 years ago. This is done for the proximate workers in the set of workers about whom the highest number of other relevant data points for reputation (e.g. reviews, box office or ratings success, 2nd and 3rd order associations, success of the reviewers, historical accuracy of the reviewers, success based on number or work requests—particularly re-hiring of workers) is obtained. From this data, a curve is derived that is then used as the default data curve for decreasing value of the recommendation over time. As more and more accurate data is obtained, the parameters of the curve are refined.

Individual reviews are able to be made available to be read or not. Individual reviewers may be anonymous to the searcher but not anonymous to the system. In this way, the system is able to most accurately appraise the capabilities of those being reviewed while protecting the anonymity of those doing the reviewing.

Fraud Detection Techniques (2211) and learning algorithms are used to counteract negative reviews that are either personal or not founded and positive reviews that are an attempt to game the system. When a review is submitted, there are a number of mechanisms that are able to be used to determine whether it is genuine or not. First, there is the general proclivity of the reviewer. If someone always gives negative reviews, there are two possible reasons. One is that they give negative reviews to everyone. If that is the case, the value of these reviews should be diminished. The other case is if the reviewer only gives reviews when they have a negative experience. These are valuable. The algorithm makes educated guesses as to which category the reviewer is in (and the category is able to change over time) based on 1) the frequency and breadth of the reviews and 2) the detail of the reviews. Frequent shallow reviews are less valuable. Also tone is indicative of value. Text parsing engines are able to be used to predict the tone of the review and if it is negative without specific instances, it should be decreased in value. The value of reviews that are detailed, not overly frequent and are not snipish in tone should not be diminished. Two other metrics for fraud should be used. The first is multiple reviews by the same person of the same person or thing over a short period of time. These reviews should be devalued. Also, the text parsing engine should look for recurring instances of the same language. This should not be used for individual terms such as “lazy” or “selfish” but rather for phrases that are long enough to indicate that they have been copied or pasted from other sources (e.g. if there was a campaign to help or hurt the ratings of someone or something).

An unfair reporting and conflict resolution mechanism will be in place. If a Ratee feels that they have been unfairly reviewed, they should cite the reviews in question and an arbitration board which has access to the identities of the reviewers will look at the details and may contact the reviewer as part of their investigation.

There are additional types of fraud detection.

People who consistently rate the same person lower or consistently rate people who work for certain other people lower (e.g., Person X rates everyone who ever worked for Steven Spielberg very low because Person X does not like Spielberg). This would include rating everyone who ever worked for a particular Director of Photography very low, for example. By maintaining a database of ratings including who did the rating and who is being rated, analysis is able to be performed to detect any consistencies or inconsistencies in the rating. If it is determined that a person is being targeted by another user, that user may be queried further to justify his ratings, those ratings may be discarded as fraudulent or the weight of the ratings may be reduced. Similarly, if a user is always rating another person positively, that is able to be detected, and similar consequences are able to be implemented.

A social graph is able to be constructed using the same second and third order described herein except negative/positive ratings are mitigated. For example, if a user tells his friends to say someone is bad or good, their ratings should be underweighted as well. Additional analysis/tracking is able to be implemented to determine fraudulent rating. For example, using time/date information, if a person is negatively rated by a cluster of people (e.g., 5, 10 or another threshold of people) within a short amount of time (e.g., 10 minutes, 1 hour, 1 day), this may indicate collusion. Furthering the example, by analyzing the social graph, if it is determined that the users all know each other, that further increases the chances of the ratings being based on collusion and are fraudulent. In some embodiments, additional analysis is used such as determining the proximity of the cluster of ratings compared to an event. For example, if a movie project just finished, it may be reasonable for the actors to all rate the director within the next 24 or 48 hours, so since the proximity to the event (e.g., end of filming) is close, the likelihood the ratings are valid is increased. However, if a cluster of actors rate a director 9 days after filming ends, all within a couple of hours of each other, since the proximity to the event is far, the likelihood the ratings are fraudulent is increased. The likelihoods are able to be used within a further analysis (e.g., calculations) of whether fraud has taken place.

In some embodiments, the system includes an averaging mechanism so that if a user rates everyone as a 1, 2 or 3, on a scale of 5, the system might raise the score for all of them by 67%, essentially grading on a curve.

In some embodiments, historical success is used to determine the veracity of these clusters of users. For example, if a contingent of people all agree spontaneously that something was bad, and it later turns out to be bad, that contingent would be determined to be a bell weather contingent.

### Dynamic Category Creation and Pruning:

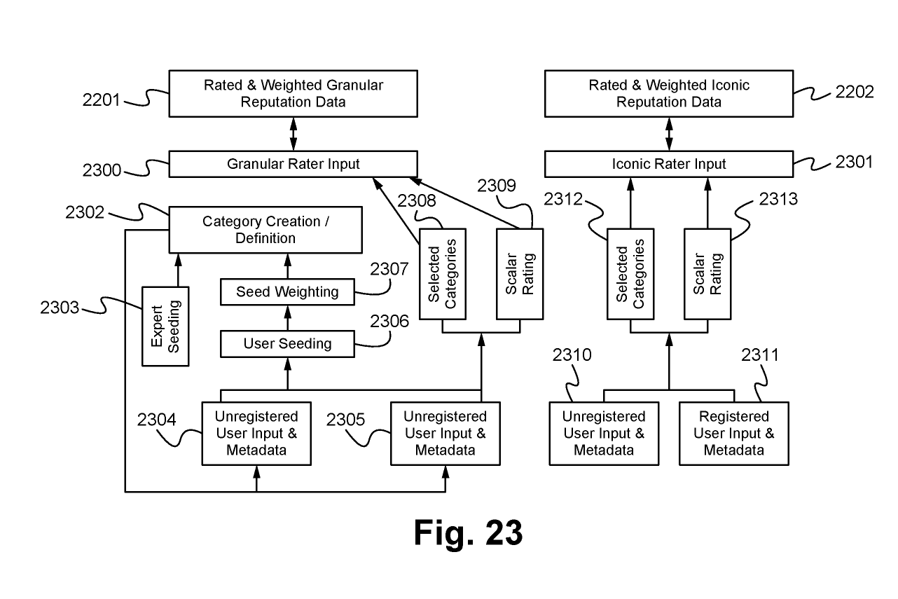

As is able to be seen in FIG. 23, the Categories that are used for rating different capabilities (2302) are seeded initially as an expert system (2303) where experts in the field have determined the initial fields of reputation for each discipline. For example, experienced Directors of Photography would be used to create the fields that are used initially in the feedback interface for recommenders. These categories (2308) are exposed to the Unregistered Users (2304) and the Registered Users (2305) who, through the User Interface, are shown the relevant categories. They may be able to select specific categories and apply Scalar Ratings (2309) to them. Once the field choices have been seeded, they should be dynamically updated (like a neural network) based on popularity. New fields will be added dynamically (2306) and are able to be based on suggestions from the Virtual Marketplace; rarely used characterizations are able to be pruned electronically and new characterizations are able to have a trial period. New parameters are able to be added dynamically and pruned algorithmically based on the Amount of use and the Historical value of that parameter.

### Iconic Reputation Engine:

Project-based Ratecons (Rate-icons): Like, Unlike or Neutral are able to be applied by anyone. They are able to be associated with a project or a worker on a project or an aspect of a project.

Though Iconic Rating works a bit differently as will be shown later, there are some factors that are similar and they are also represented in FIG. 23. Of course, one could use the exact same categories that are used for Granular Reputation input for Iconic Rater input but this will often not be the case as Iconic Rating may typically be more cursory. First, looking at the Scalar Rating—this scale is limited to Thumbs Up, Thumbs Down and possibly Thumbs Neutral. This represents only two or three scales as opposed to a numbered scale which might typically be from 1 to 5 but could be any arbitrary scale (e.g., from 1 to 100). As mentioned above, the same categories as are used in the Granular Rater Input are able to be used for Iconic Rater Input but quite likely there will be fewer categories. Casual users might typically rate the whole film or the lead actress but less likely the Director of Photography (DP) or another less public role. However, if they are a Camera Operator, they would likely have an opinion about the DP and so, based on their historical role—if they are Registered Users (2311), a limited set of categories are able to be exposed to them. The likely goal is to enable people to quickly give ratings and so it may be important to limit the fields to just a few.

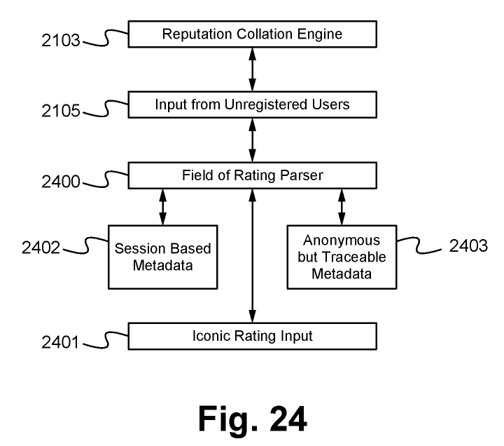

For Unregistered Users (2310), the problem is a bit more difficult. Some of these users may be traceable based on the use of Cookies or other tracking mechanisms and in that case, some Implied Categories (2312) are able to be generated based on their history. Looking at FIG. 24, the Reputation Collation Engine (2103) receives Input from Unregistered Users, and that data has been broken into the appropriate domains by the Field of Rating Parser (2400). These fields are able to be generated by the user selecting an area (e.g. from a drop-down menu) to review or by implying an area of expertise based on the context. There are two kinds of anonymous users 1) those who allow tracking using cookies or other similar mechanisms and are able to be followed from session to session and 2) users who are completely anonymous and data are only able to be gathered from the current session.

For the first group, things such as what other content they have watched, where they paused or replayed specific content, what content they did not finish watching, are able to be used to develop a profile on this user. Even for completely anonymous Users, data is able to be gathered based solely on their viewing behavior during the playback and the type of media being consumed. If, for example, it is a highly effects laden piece, they might be asked about the quality of the effects. If it is a comedy, they might be asked if they thought it was funny.

As mentioned above, project-based Ratecons (Rate-icons): Like, Unlike or Neutral are able to be applied during the process of working on the project by anyone working on that project. Anyone is able to rate as often as they want. The value of a Ratecon is weighted based on two axes:

How often are the Ratecons used? If they are used once a day or less, they are taken to refer to the project since the last rating (therefore if the only rating is at the end, it refers to the whole project). If they are used more than once a day, they are taken to refer to that day but are averaged into one rating for the day.

The value of the rater is determined taking into consideration two components: How high is their rating and how senior are they in the project. Additionally, their rating will be adjusted in retrospect based on how successful the project was compared to how highly they rated it.

Person-based Ratecons are able to be applied by anyone to anyone. Anyone is able to rate as often as they want. The value of a Person-based Ratecon is weighted based on two axes: How recently did the Rate-or rate the Rate-e with the value diminishing linearly over time (even if no new ratings). Also, every new rating diminishes the value of previous ratings. The algorithm which determines the diminution of the value of the rating over time will be fine-tuned—as it was above for Granular Reputation Engines, based on the historical accuracy of the ratings. If ratings hold up well over time, the algorithm will reflect that. If ratings lose their relevance fairly quickly, that will be reflected by the algorithm. Also, external factors such as seasonality, collaborative filtering, weather and time of day are able to be factored in and if they turn out to be relevant to the final accuracy, they will be included as inputs to the algorithms. Just as with Granular Reputation Data, Iconic Reputation Data takes as its input Rater Proximity in the Field or from their Work History (2208), the Rating of the Rater (2207) and the impact of 2nd and 3rd order Weighting.

Input from Commercial and Public Sources:

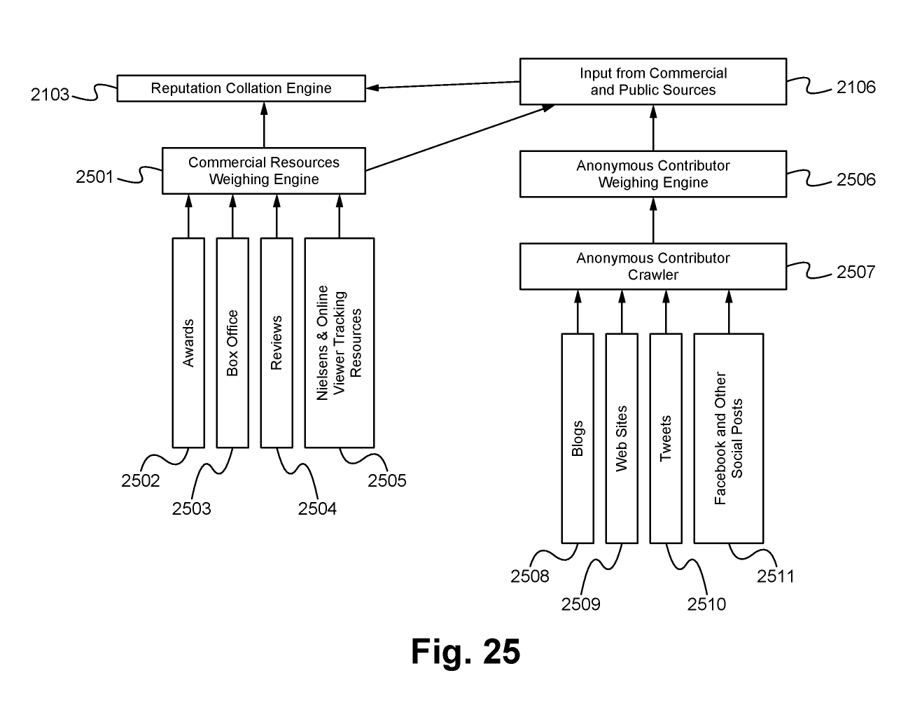

In many industries, but particularly in the media space, there is a lot of publicly available data on media assets and the contributors to those assets. There are Nielsen ratings for TV shows and box office results for movies. There are well respected reviewers at major publications and bloggers writing about the assets and the contributors. There are also comments on social networks (Facebook, Twitter) and these are able to be crawled, scraped and parsed. Some of the contributors are able to be traced across posts and comments and others are completely anonymous. FIG. 25 is a diagram which addresses capturing recommendations from across this diverse space.

These elements are fed into a Reputation Collation Engine (2103) where they ultimately join all the other forms of reputation from the other figures. These elements represent the Input from Commercial and Public Sources (2106). There are two sets of data that are combined here. The first comes out of the Commercial Resources Weighting Engine (2501). The elements that feed this engine are Awards (2502), Box Office receipts (2503), Reviews (2504) and Viewer tracking Resources (like the Nielsens or Google Analytics). Data regarding Awards and Box office receipts are able to be gathered from commercial sources like Studio System (http://studiosystem.com/) or IMDB (http://www.imdb.com/) or Screen Digest (https://technology.ihs.com/Industries/450465/media-intelligence) which have APIs that are able to be accessed by third parties for this purpose. Data for reviews are able to be collated from the various publications. Data from traditional review sources such as magazines (Variety, Hollywood Reporter), newspapers (LA Times, NT Times) are joined with pure online resources such as Rotten Tomatoes, Metacritic and plugged In. These sites are publicly available, and the ratings are able to be aggregated. Also, data about viewership is able to be aggregated from sources such as Nielsen and directly from online services like YouTube and Vimeo.

In addition to these commercial aggregators of data there is data from Anonymous Contributors (2506). This data is gathered by an Anonymous Contributor Crawler (2507) which crawls the web including Facebook, Twitter and the Blogosphere, collecting posts, tweets, likes and comments from the web about various media properties and the participants in the creation of those properties. Intelligent text parsing algorithms are able to take this data and use it to develop reputation reflecting public sentiment regarding all the participants.

### Structuring the Query:

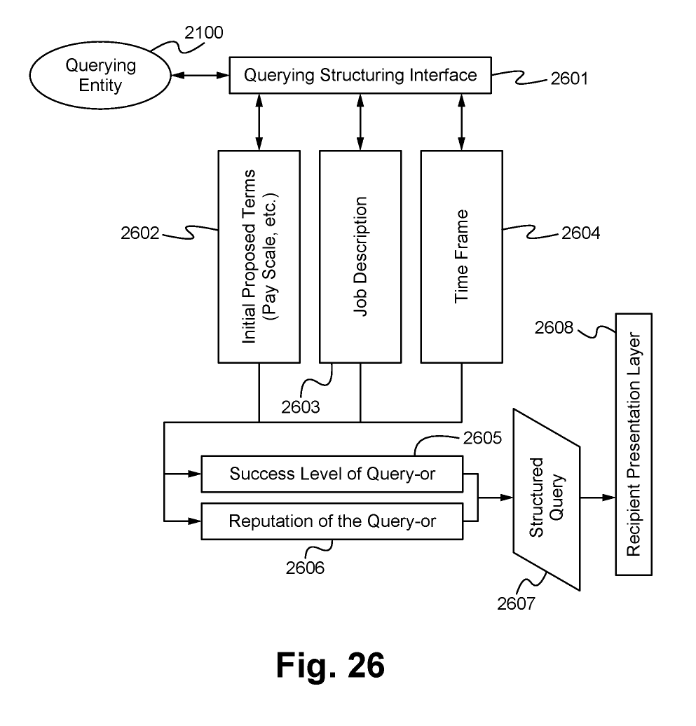

All of this comes together in the structuring of a Query. As is able to be seen in FIG. 26, when a Querying Entity (e.g. a Producer or a Studio) wants to search for talent, it may ask for the recommendations from a broad set of possible contributors based on parameters like type of work, location, reputation, pay range, and experience. An offer might typically include the Job Description (2603), The Timeframe in which the work is expected to be done (2604) and may include Initial Proposed Terms (2602) like price and credits. This data is not initially used to make the offer but rather to frame the request for employees that fit the description. For example, one might request a Camera Operator in the Boston area who is highly recommended but not very experienced (e.g. expensive) for a low budget film. After the choices are brought back to the Query Structuring Interface (2601), an offer is able to be made in the form of a Structured Query (2607). The recipients view the offer through the Recipient presentation Layer (2608) where they are able to see the Success level (e.g., previous films, box office success) of the Query-or (2605) and the Reputation of the Query-or (2606). Because there is transparency on both sides, a proper understanding of the capabilities and reputation of both parties is understood, and a better informed negotiation is able to take place.

### Task Hierarchies

In visual Media, Workers are divided into jobs with roughly the following hierarchies:

### 1. Director

### 1.1. Second Unit Director

### 1.2. First Assistant Director

### 1.3. Second Assistant Director

### 1.4. Other Assistant Directors

### 2. Producer

### 2.1. Executive Producer

2.1.1. Line producer

### 2.1.2. Production Assistant

### 2.2. Production Manager

### 2.2.1. Assistant Production Manager

### 2.2.2. Unit Manager

### 2.2.3. Production Coordinator

### 2.3. Production Accountant

### 2.4. Location Manager

### 2.4.1. Assistant Location Manager

### 2.4.2. Location Scout

### 2.4.3. Location Assistant

### 2.4.4. Location Production Assistant

### 2.5. Script Supervisor

### 2.6. Casting Director

### 2.6.1. Actors

### 2.7. Director of Photography (Cinematographer)

### 2.7.1. Camera Operator

### 2.7.2. First Assistant Camera

### 2.7.3. Second Assistant Camera

### 2.7.4. Digital Imaging Technician

### 2.8. Gaffer (Lighting)

### 2.8.1. Best boy (Lighting)

### 2.8.2. Lighting Technician

### 2.9. Electricians

2.9.1. Key grip

### 2.9.2. Best boy (Grip)

### 2.10. Production Designer

### 2.10.1. Art Director

### 2.10.2. Set Designer

### 2.10.3. Illustrator

### 2.10.4. Graphic Artist

### 2.11. Sound/Music

### 2.11.1. Music Supervisor

### 2.11.2. Composer

### 2.11.3. Sound Designer

### 2.11.4. Dialogue Editor

### 2.11.5. Sound Editor

### 2.11.6. Re-recording Mixer

### 2.11.7. Foley Artist

### 2.12. VFX Producer

### 2.12.1. VFX Supervisor

### 2.12.1.1. Facility CG Supervisor

### 2.12.1.1.1. Lead Technical Director

### 2.12.2. Facility VFX Supervisor

### 2.12.2.1. Lead Compositors

### 2.13. Make-up Artist

### 2.14. Hair Stylist

As described herein veracity, as well as other aspects of the methods, is able to be used with respect to other entities such as journalists. An accuracy prediction engine is able to be utilized to generate a veracity index. There is also a layer for allowing a reader/viewer to map stories against the reader's/viewer's own historical view.

The process begins with input from various sources to ultimately display a “Veracity Score” associated with an article. The process includes:

1. Acquiring opinions from two different kinds of sources:

a. Registered Users (accountable for their opinion)

b. Anonymous/Semi-anonymous users and other Public Sources.

2. Collating all the data from the sources and storing the data in a Veracity Information Database.
3. Using a series of filters to parse the opinions about the data, including data about the sources (e.g., NY Times vs. anonymous blogger).
4. Applying user-specific filters biased by historical usage, general preferences and settings which determine how close or far a user wants from a pre-disposed opinion (e.g., less or more serendipity).

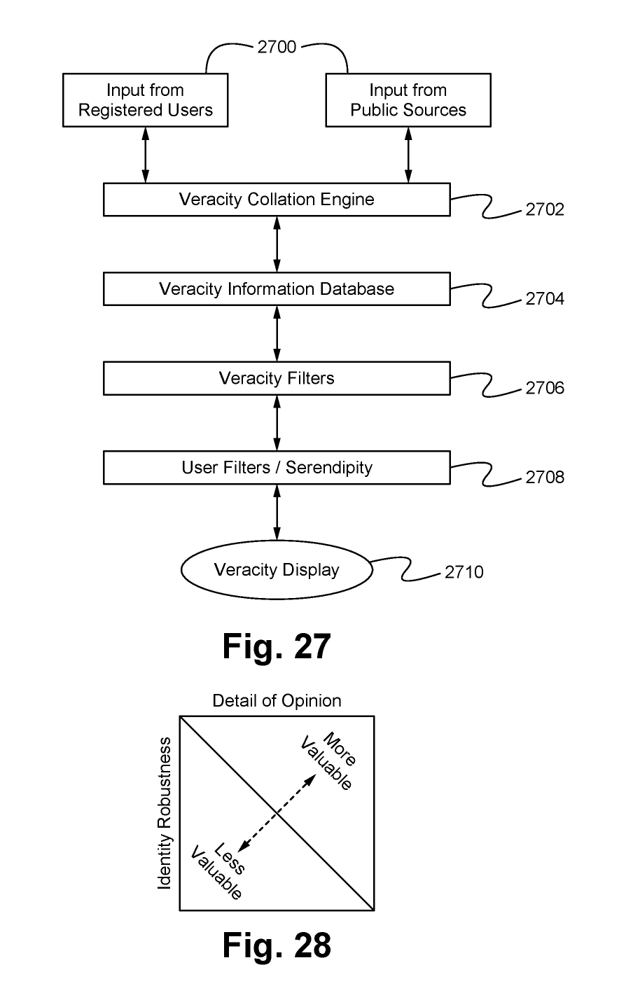

FIG. 27 illustrates a flowchart of a process of assessing veracity according to some embodiments. In the step 2700, input is received. The input is received from sources such as registered users, non-registered users (e.g., public sources) and/or any other sources. The input is received in any manner such as a user selecting thumbs up or thumbs down and/or providing text input such as a comment regarding an article. In the step 2702, the data is collated using a veracity collation engine. Collating the data involves organizing the data such as classifying selections. In the step 2704, the input and any additional data (e.g., a link to the article) are stored in a veracity information database. In the step 2706, a series of filters is used to parse the opinions about the data. The filters are able to be used to: determine information about the user making selections (e.g., the user is registered versus non-registered, the user is a well-respected journalist versus a random person expressing a personal opinion), and classify what the user input and provide specific weightings to the input (e.g., an input value for accuracy may be weighted more than an input value for the grammar) In the step 2708, user-specific filters are applied to the data. User-specific filters enable users to provide details such that a veracity score is more tailored towards them and their preferences. For example, a user may adjust a weighting scheme such that grammar is most important or not important at all. In another example, the general filter is not affected, but a veracity score is modified if the content of the article does not agree with personal preferences selected by the user. In the step 2710, a veracity score is displayed. The veracity score is able to be displayed in any manner such as displaying a score at the top of an article. In some embodiments, fewer or additional steps are implemented. In some embodiments, the order of the steps is modified. In some embodiments, the analysis described above regarding reputation is utilized in determining the veracity score.

The sources bifurcate on two different axes, as shown in FIG. 28. The first is the accountability of the person expressing his/her opinion: are they anonymous or are they known and is their history known with some robustness. The second is around the detail (e.g., breadth) with which they express their opinion: is it just a general thumbs up/thumbs down approach (similar to Facebook®) (little detail/breadth) or is it a more granular set of opinions on a scale (like TripAdvisor®) (significant detail/breadth). For example, user input with a significant amount of detail (also referred to as a significant amount of breadth) is more helpful and thus is given more weight than user input with a small amount of detail (or less breadth). An amount of detail or breadth is able to be determined in any manner such as based on word count, word relevancy or a combination thereof. These two axes create a continuum of relevance that go from detailed reviews coming from robustly identified individuals to casual opinions from unknown entities. The relative value of these opinions is used to determine the Veracity Rating. What follows is detail around what goes into the weighting of these opinions and how the opinions are used to determine the Veracity Rating.

The articles and journalists are rated using parameters. In some embodiments, the parameters are generated by a board of experts. The parameters are able to change over time based on feedback, amount of use, value in determining outcomes, and/or other factors. The parameters include aspects such as current accuracy (e.g., I know or believe this to be accurate or not because I was there or believe people who were there), historical accuracy (looking back at a story from the past, events have now proven the statements/predictions to be true or not), writing style, understandability, bias (or lack of), relevance to the topic, and other parameters. If other users want to generate new parameters/categories, they are allowed to, in some embodiments. If enough people generate/select a new parameter/category, the parameter/category will be added to the parameter/category list. Reciprocally, if a parameter/category is rarely used, the parameter/category will be pruned out. Thus, a dynamic group of parameters/categories will exist that will likely be stable for periods of time but will naturally evolve as society does.

After generating the parameters, the parameters are displayed to the users/reviewers in a grid with a scale (e.g., from one to five) associated with each parameter. For example, when a user views an article, at the top or bottom of the article, the parameters are displayed (e.g., using html and/or any other coding language). The reviewer does not need to choose all parameters. The reviewer might pick only “1” on readability because they were confused by the article and wanted to express that. Alternatively, the reviewer could choose to pick values for all categories, and additionally write comments (which are able to be parsed with natural language parsers and used to provide further detail for the Veracity Engine). The parameters and/or grid are able to be displayed in a web browser or another display.

The reviewers choose their parameters/categories and associate their ranking for each category. Each review is associated with a reviewer ID, and the weighting of that review is able to be determined based on the expected or historical accuracy of that reviewer. Once a Veracity Index has been associated with each reviewer, then the Veracity Index, the categories reviewed and the scalar ratings for each review are formatted and stored.

The Veracity Index for each reviewer is determined using a number of elements. The first element is expertise in the field of topic. If someone is a working musician, their Veracity Index when commenting on other musicians has more value than someone not in the field. In similar fashion, people who work in politics will be better able to judge a political article, and an economist would be better able to judge a story about the Federal Reserve. Once a short period of time has passed, historical accuracy is able to be used to adjust contributors' Veracity Index. If a financial analyst is bullish on Amazon®, and the stock goes down, that is one data point. The data is able to be gathered in any manner (e.g., tracking user comments/opinions). The sum of the data will give an indication of the accuracy of the analyst. Some judgments on accuracy may happen rather quickly, while others (e.g., Kurzweil's date for the Singularity) may take a bit longer.

The system starts with known quantities (e.g., a Wall Street Journal article is presumed to be more accurate than a fan blog), and the system learns as it gets more granular. For example, it may be presumed that Joanna Stern's article about a new camera is probably accurate, but it may be learned that a reviewer on DigitalPhotographyReview.com is ultimately more reliable in the field.

All of this is able to be further optimized based on the expectation of the reader so that for the casual reader one review might be best, but for the professional reviewer, different reviews would be more appropriate. This will evolve over time, and readers may want to reveal more about themselves to get the full value of the customization. This does not, however, impact the basic principles of veracity of different articles and publications across the board. Additionally, the accuracy of association with the individual reader is able to be easily judged based on their review of the article or their thumbs up/down of the article or of the Veracity Index.

There is another form of review that is the more casual, the thumbs up/thumbs down mechanism. This can be applied in two different ways:

1) A reader is able to thumbs up or down any story.
2) A reader is able to thumbs up or down the Veracity Index for that story (in a sense judging the judgment).

When weighing the thumbs up/down mechanism, generally, there is little value to the veracity of the story, but there is much value to the popularity of the story. However, there is able to be a small place on the page/screen where a thumbs up icon is next to the word “accurate,” and the thumbs down icon is next to the word “inaccurate” (or some similar mechanism), and this is able to be a good measure of general sentiment. All of these various approaches are able to be tried and compared against each other for results.

There is one further axis on which the veracity of the reviewer pivots, and that is accountability. If a reviewer is identified, and much is known about them (e.g., I am a journalist for the Washington Post), the value of their review is increased, and by contrast, reviews by anonymous contributors have very little value.

In some embodiments, fraud detection and prevention is implemented. Some participants will want to game the system either for or against a particular outlet or journalist. Technologies are able to be implemented to monitor for, detect and prevent fraud.

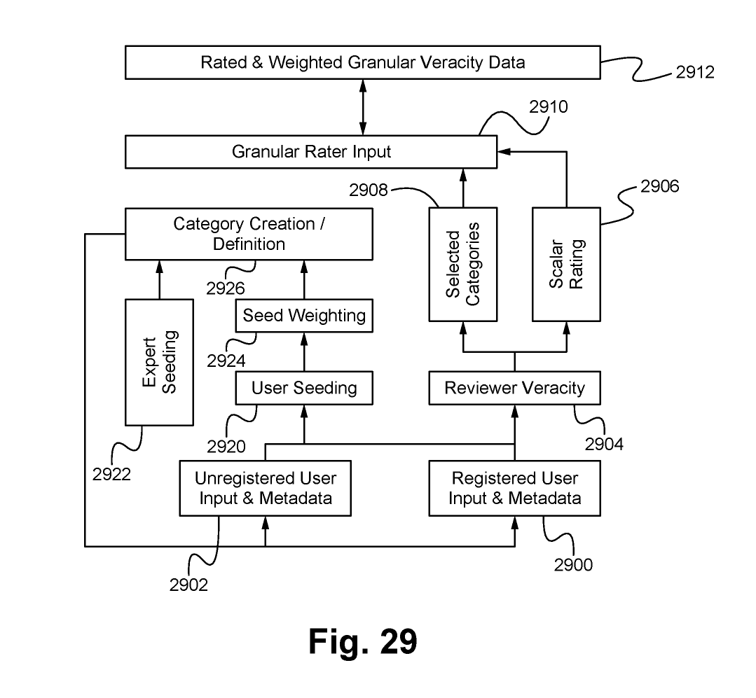

FIG. 29 illustrates a diagram of analyzing user input to generate veracity information according to some embodiments. Registered users provide input in the step 2900, and unregistered users provide input in the step 2902. The input provided by the users is able to be any input such as rating information (e.g., thumbs up/down), ideas for additional parameters/categories, opinion information, commentary and/or any other information. Additionally, user metadata is acquired. For example, based on the user's name, additional information is determined using a web crawl search. The reviewer's veracity is determined, in the step 2904. The reviewer veracity is able to be determined in any manner such as based on the user's occupation/skill set, reputation information based on previous input/comments, and/or any other information. In the step 2906, a scalar rating (e.g., 1 through 5) is determined. The scalar rating may simply be a value selected or input by a user regarding a journalist or an article. In some embodiments, each parameter/category is able to receive a scalar rating (e.g., user gives article a 1 for accuracy). In the step 2908, the parameters/categories selected are determined. For example, the system determines which parameter fields have been selected or have an entry. Although a user may be presented with 5 (or any other number) parameters to rate an article, the user may select 1 or more of the parameters. In the step 2910, the granular rater input is analyzed. The granular rater input is without any weighting or manipulation of the input. For example, if random person Joe inputs a value of 5 for one of the parameters, and a professional journalist inputs a 5, that is the same granular input, since it is before any weighting or any other manipulation. In the step 2912, rated and weighted granular veracity data for an article or journalist is generated. The granular input is weighted based on a variety of factors such as reviewer veracity, being registered or not, and/or any other weighting scheme.

Additionally, parameters/categories are able to be generated based on user seeding and expert seeding. In the step 2920, users are able to provide additional parameters/categories for rating articles/journalists. In the step 2922, experts are able to provide additional parameters/categories for rating articles/journalists. In the step 2924, the users are able to provide recommended weightings for the proposed parameters/categories. For example, a user submits that the age of the journalist should be a parameter regarding veracity, but provides that the parameter only receives a low weight, since age may only be loosely related to veracity. In the step 2924, the system then generates parameters/categories based on the expert and user input. Included in the generation of the parameters/categories is the input mechanism to select the newly generated parameters/categories.

The veracity scale for journalists is able to be used with any computing device as described herein. The veracity scale enables readers/viewers to input and check the veracity of the articles they are reading.

### Some Embodiments of Veracity Scale for Journalists

1. A method programmed in a non-transitory memory of a device comprising:
   a. acquiring input from a user regarding an article or a journalist;
   b. collating and storing the input in a database;
   c. filtering the input to generate filtered data;
   d. applying a user-specific filter to the filtered data to generate veracity information related to the article or the journalist; and
   e. displaying the veracity information.
2. The method of clause 1 wherein the user is one of a registered user or a non-registered user, wherein the input from the registered user is valued more than the input from the non-registered user.
3. The method of clause 1 wherein the input from the user is classified based on breadth of the input, such that the input with more breadth is more valuable than input with less breadth.
4. The method of clause 1 wherein the input from the user is a rating of the article based on one or more parameters.
5. The method of clause 4 wherein the one or more parameters include at least one of: current accuracy, historical accuracy, writing style, understandability, bias and relevance to a topic.
6. The method of clause 4 wherein the one or more parameters are dynamic such that the one or more parameters evolve over time based on feedback, amount of use, or value in determining outcomes.
7. The method of clause 4 wherein the input from the user includes information to generate an additional parameter.
8. The method of clause 7 wherein the additional parameter is added to a parameter list upon being approved by a specified number of users.
9. The method of clause 8 wherein when a parameter of the one or more parameters is rarely used, the parameter is removed from the parameter list.
10. The method of clause 4 wherein the one or more parameters are displayed in a grid with a scale rating in a web browser.
11. The method of clause 1 wherein the user has a veracity index based on an expertise of the user and historical accuracy of the user.
12. An apparatus comprising:
   a. a non-transitory memory for storing an application, the application for:
      i. acquiring input from a user regarding an article or a journalist;
      ii. collating and storing the input in a database;
      iii. filtering the input to generate filtered data;
      iv. applying a user-specific filter to the filtered data to generate veracity information related to the article or the journalist; and
      v. displaying the veracity information; and
   b. a processing component coupled to the memory, the processing component configured for processing the application.
13. The apparatus of clause 12 wherein the user is one of a registered user or a non-registered user, wherein the input from the registered user is valued more than the input from the non-registered user.
14. The apparatus of clause 12 wherein the input from the user is classified based on breadth of the input, such that the input with more breadth is more valuable than input with less breadth.
15. The apparatus of clause 12 wherein the input from the user is a rating of the article based on one or more parameters.
16. The apparatus of clause 15 wherein the one or more parameters include at least one of: current accuracy, historical accuracy, writing style, understandability, bias and relevance to a topic.
17. The apparatus of clause 15 wherein the one or more parameters are dynamic such that the one or more parameters evolve over time based on feedback, amount of use, or value in determining outcomes.
18. The apparatus of clause 15 wherein the input from the user includes information to generate an additional parameter.
19. The apparatus of clause 18 wherein the additional parameter is added to a parameter list upon being approved by a specified number of users.
20. The apparatus of clause 19 wherein when a parameter of the one or more parameters is rarely used, the parameter is removed from the parameter list.
21. The apparatus of clause 15 wherein the one or more parameters are displayed in a grid with a scale rating in a web browser.
22. The apparatus of clause 12 wherein the user has a veracity index based on an expertise of the user and historical accuracy of the user.
23. A system comprising:
   a. an acquisition module for acquiring input from a user regarding an article or a journalist;
   b. a collating module for collating and storing the input in a database;
   c. a filtering module for filtering the input to generate filtered data;
   d. a user-specific filtering module for applying a user-specific filter to the filtered data to generate veracity information related to the article or the journalist; and
   e. a display module for displaying the veracity information.
24. The system of clause 23 wherein the user is one of a registered user or a non-registered user, wherein the input from the registered user is valued more than the input from the non-registered user.
25. The system of clause 23 wherein the input from the user is classified based on breadth of the input, such that the input with more breadth is more valuable than input with less breadth.
26. The system of clause 23 wherein the input from the user is a rating of the article based on one or more parameters.
27. The system of clause 26 wherein the one or more parameters include at least one of: current accuracy, historical accuracy, writing style, understandability, bias and relevance to a topic.
28. The system of clause 26 wherein the one or more parameters are dynamic such that the one or more parameters evolve over time based on feedback, amount of use, or value in determining outcomes.
29. The system of clause 26 wherein the input from the user includes information to generate an additional parameter.
30. The system of clause 29 wherein the additional parameter is added to a parameter list upon being approved by a specified number of users.
31. The system of clause 30 wherein when a parameter of the one or more parameters is rarely used, the parameter is removed from the parameter list.
32. The system of clause 26 wherein the one or more parameters are displayed in a grid with a scale rating in a web browser.
33. The system of clause 23 wherein the user has a veracity index based on an expertise of the user and historical accuracy of the user.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
a. acquiring input from a user regarding an article or a journalist;
b. collating and storing the input in a database;
c. filtering the input to generate filtered data;
d. applying a user-specific filter to the filtered data to generate veracity information related to the article or the journalist; and
e. displaying the veracity information.

2. The method of claim 1 wherein the user is one of a registered user or a non-registered user, wherein the input from the registered user is valued more than the input from the non-registered user.

3. The method of claim 1 wherein the input from the user is classified based on breadth of the input, such that the input with more breadth is more valuable than input with less breadth.

4. The method of claim 1 wherein the input from the user is a rating of the article based on one or more parameters.

5. The method of claim 4 wherein the one or more parameters include at least one of: current accuracy, historical accuracy, writing style, understandability, bias and relevance to a topic.

6. The method of claim 4 wherein the one or more parameters are dynamic such that the one or more parameters evolve over time based on feedback, amount of use, or value in determining outcomes.

7. The method of claim 4 wherein the input from the user includes information to generate an additional parameter.

8. The method of claim 7 wherein the additional parameter is added to a parameter list upon being approved by a specified number of users.

9. The method of claim 8 wherein when a parameter of the one or more parameters is rarely used, the parameter is removed from the parameter list.

10. The method of claim 4 wherein the one or more parameters are displayed in a grid with a scale rating in a web browser.

11. The method of claim 1 wherein the user has a veracity index based on an expertise of the user and historical accuracy of the user.

12. An apparatus comprising:
a. a non-transitory memory for storing an application, the application for:
i. acquiring input from a user regarding an article or a journalist;
ii. collating and storing the input in a database;
iii. filtering the input to generate filtered data;
iv. applying a user-specific filter to the filtered data to generate veracity information related to the article or the journalist; and
v. displaying the veracity information; and
b. a processing component coupled to the memory, the processing component configured for processing the application.

13. The apparatus of claim 12 wherein the user is one of a registered user or a non-registered user, wherein the input from the registered user is valued more than the input from the non-registered user.

14. The apparatus of claim 12 wherein the input from the user is classified based on breadth of the input, such that the input with more breadth is more valuable than input with less breadth.

15. The apparatus of claim 12 wherein the input from the user is a rating of the article based on one or more parameters.

16. The apparatus of claim 15 wherein the one or more parameters include at least one of: current accuracy, historical accuracy, writing style, understandability, bias and relevance to a topic.

17. The apparatus of claim 15 wherein the one or more parameters are dynamic such that the one or more parameters evolve over time based on feedback, amount of use, or value in determining outcomes.

18. The apparatus of claim 15 wherein the input from the user includes information to generate an additional parameter.

19. The apparatus of claim 18 wherein the additional parameter is added to a parameter list upon being approved by a specified number of users.

20. The apparatus of claim 19 wherein when a parameter of the one or more parameters is rarely used, the parameter is removed from the parameter list.

21. The apparatus of claim 15 wherein the one or more parameters are displayed in a grid with a scale rating in a web browser.

22. The apparatus of claim 12 wherein the user has a veracity index based on an expertise of the user and historical accuracy of the user.

23. A system comprising:
a. an acquisition module for acquiring input from a user regarding an article or a journalist;
b. a collating module for collating and storing the input in a database;
c. a filtering module for filtering the input to generate filtered data;
d. a user-specific filtering module for applying a user-specific filter to the filtered data to generate veracity information related to the article or the journalist; and
e. a display module for displaying the veracity information.

24. The system of claim 23 wherein the user is one of a registered user or a non-registered user, wherein the input from the registered user is valued more than the input from the non-registered user.

25. The system of claim 23 wherein the input from the user is classified based on breadth of the input, such that the input with more breadth is more valuable than input with less breadth.

26. The system of claim 23 wherein the input from the user is a rating of the article based on one or more parameters.

27. The system of claim 26 wherein the one or more parameters include at least one of: current accuracy, historical accuracy, writing style, understandability, bias and relevance to a topic.

28. The system of claim 26 wherein the one or more parameters are dynamic such that the one or more parameters evolve over time based on feedback, amount of use, or value in determining outcomes.

29. The system of claim 26 wherein the input from the user includes information to generate an additional parameter.

30. The system of claim 29 wherein the additional parameter is added to a parameter list upon being approved by a specified number of users.

31. The system of claim 30 wherein when a parameter of the one or more parameters is rarely used, the parameter is removed from the parameter list.

32. The system of claim 26 wherein the one or more parameters are displayed in a grid with a scale rating in a web browser.

33. The system of claim 23 wherein the user has a veracity index based on an expertise of the user and historical accuracy of the user.
